(19) United States
(12) Patent Application Publication
(10) Pub. No.: US 2013/0052549 A1
(43) Pub. Date: Feb. 28, 2013

(54) ANION-EXCHANGE-MEMBRANE TYPE OF FUEL-CELL-SYSTEM

(71) Applicants: Hirotaka Mizuhata, Osaka (JP); Akihito Yoshida, Osaka (JP); Shunsuke Sata, Osaka (JP)

(72) Inventors: Hirotaka Mizuhata, Osaka (JP); Akihito Yoshida, Osaka (JP); Shunsuke Sata, Osaka (JP)

(21) Appl. No.: 13/592,979

(22) Filed: Aug. 23, 2012

(30) Foreign Application Priority Data
Aug. 25, 2011 (JP) 2011-183749

(51) Int. Cl. H01M 8/06

(52) U.S. Cl. 429/412

(57) ABSTRACT

An anion-exchange-membrane type of fuel-cell-system includes: a fuel cell part; and a carbon dioxide eliminating part, wherein the fuel cell part comprises a fuel electrode, an air electrode, an anion-exchange type of solid polymer electrolyte membrane sandwiched between the fuel electrode and the air electrode, a fuel channel that supplies a fuel gas to the fuel electrode, and an air channel that supplies air or an oxygen gas to the air electrode, and the carbon dioxide eliminating part is configured to eliminate carbon dioxide which is mixed in the fuel gas when the fuel gas flows through the fuel channel, and to allow the fuel gas to flow again into the fuel channel after eliminating the carbon dioxide.

### CROSS-REFERENCE TO RELATED APPLICATION

This application is related to Japanese Patent Application No. 2011-183749 filed on Aug. 25, 2011, whose priority is claimed under 35 USC §119, and the disclosure of which is incorporated by reference in its entirety.

### BACKGROUND OF THE INVENTION

1. Field of the Invention

The present invention relates to an anion-exchange-membrane type of fuel-cell-system.

2. Description of the Background Art

An alkaline fuel cell having an anion exchange membrane used as a solid polymer electrolyte membrane can employ, as an electrode catalyst, a catalyst other than a noble metal. Therefore, the alkaline fuel cell of this type can be manufactured with reduced cost. Accordingly, the alkaline fuel cell has been researched and developed as a fuel cell to replace a fuel cell having a cation exchange membrane as a solid polymer electrolyte membrane.

FIG. 14 is a schematic sectional view of an alkaline fuel cell having an anion exchange membrane as a solid polymer electrolyte membrane. The alkaline fuel cell includes a fuel electrode 51, an air electrode 52, a solid polymer electrolyte membrane 53 that has OH⁻ as conductive species, and that is sandwiched between the fuel electrode 51 and the air electrode 52, a fuel channel 60 that supplies a fuel gas to the fuel electrode 51, and an air channel 61 that supplies air and water to the air electrode 52. On the air electrode 52, O₂ and H₂O supplied from the air channel 61 and an electron on the air electrode 52 react to generate OH⁻. The OH⁻ generated on the air electrode 52 moves through the solid polymer electrolyte membrane 53 by an ion conduction to move to the fuel electrode 51, and reacts with H₂ supplied from the fuel channel 60 to generate H₂O, whereby electrons are emitted to the fuel electrode 51. With the progress of the cell reaction as described above, an electromotive force is generated between the air electrode 52 and the fuel electrode 51, resulting in that an electric power can be extracted.

However, it has been known that, in the alkaline fuel cell, carbon dioxide (CO₂) in the air channel 61 or the fuel channel 60 affects the solid polymer electrolyte membrane 53, thereby deteriorating a power generation efficiency of the fuel cell. The deterioration in the power generation efficiency is considered to be caused because the ion conductivity of the solid polymer electrolyte membrane 53 is reduced due to a progress of a carbonation of the solid polymer electrolyte membrane 53, or because an overvoltage in the electrode reaction is increased due to the influence of the carbon dioxide. It is considered that the ion conductivity of the carbonated solid electrolyte membrane is reduced, because CO₂ is dissolved into the solid polymer electrolyte membrane 53 to generate HCO₃−, and the generation of HCO₃— decreases the amount of OH— that is the main conductive species. HCO₃—moves through the solid polymer electrolyte membrane 53 due to the ion conduction to be discharged to the fuel channel 60 as CO₂.

In order to prevent the deterioration in the power generation efficiency of the fuel cell, a conventional alkaline fuel cell preliminarily eliminates CO₂ contained in the air supplied to the air channel (see, for example, Japanese Unexamined Patent Publication No. 2011-34710).

However, in the alkaline fuel cell, CO₂ dissolved into the solid polymer electrolyte membrane is emitted to the fuel channel, so that an unreacted fuel gas exhausted from the fuel channel contains CO₂. Therefore, in the conventional alkaline fuel cell, when the unreacted fuel gas is supplied again to the fuel channel to be reused, CO₂ is also supplied to the fuel channel, which might entail a problem of a deterioration in the power generation efficiency of the fuel cell.

### SUMMARY OF THE INVENTION

The present invention is accomplished in view of the above-mentioned circumstance, and aims to provide a fuel cell system that can reuse an unreacted fuel cell as a fuel without entailing a deterioration in a power generation efficiency of the fuel cell.

The present invention provides an anion-exchange-membrane type of fuel-cell-system including: a fuel cell part; and a carbon dioxide eliminating part, wherein the fuel cell part includes a fuel electrode, an air electrode, an anion exchange solid polymer electrolyte membrane sandwiched between the fuel electrode and the air electrode, a fuel channel that supplies a fuel gas to the fuel electrode, and an air channel that supplies air or an oxygen gas to the air electrode, and the carbon dioxide eliminating part is configured to eliminate carbon dioxide which is mixed in the fuel gas when the fuel gas flows through the fuel channel, and to allow the fuel gas to flow again in the fuel channel after eliminating the carbon dioxide.

According to the present invention, the carbon dioxide eliminating part is configured to eliminate carbon dioxide which is mixed in the fuel gas when the fuel gas flows through the fuel channel, and to allow the fuel gas to flow again in the fuel channel after eliminating the carbon dioxide. Accordingly, an unreacted fuel gas contained in the fuel gas that flowed through the fuel channel can be reused as a fuel gas, whereby a use efficiency of the fuel gas can be enhanced. Since the carbon dioxide which is mixed in the fuel gas when the fuel gas flows through the fuel channel can be eliminated by the carbon dioxide eliminating part, the unreacted gas from which the carbon dioxide has been eliminated can be supplied to the fuel channel, with the result that the deterioration in the power generation efficiency of the fuel cell, which is caused by the carbon dioxide contained in the fuel gas, can be prevented.

### BRIEF DESCRIPTION OF THE DRAWINGS

FIG. 1 is a schematic piping diagram of a fuel-cell-system according to one embodiment of the present invention;

FIG. 2 is a schematic sectional view of a fuel cell part included in the fuel-cell-system according to one embodiment of the present invention;

FIG. 3 is a schematic piping diagram of a fuel-cell-system according to one embodiment of the present invention;

FIG. 4 is a schematic plan view illustrating a configuration of a hydrogen production device included in the fuel-cell-system according to one embodiment of the present invention;

FIG. 5 is a schematic sectional view of the hydrogen production device taken along a chain line A-A in FIG. 4;

FIG. 6 is a schematic back view illustrating the configuration of the hydrogen production device included in the fuel-cell-system according to one embodiment of the present invention;

FIG. 7 is a schematic sectional view illustrating the configuration of the hydrogen production device included in the fuel-cell-system according to one embodiment of the present invention;

FIG. 8 is a schematic sectional view illustrating the configuration of the hydrogen production device included in the fuel-cell-system according to one embodiment of the present invention;

FIG. 9 is a schematic sectional view illustrating the configuration of the hydrogen production device included in the fuel-cell-system according to one embodiment of the present invention;

FIG. 10 is a schematic sectional view illustrating the configuration of the hydrogen production device included in the fuel-cell-system according to one embodiment of the present invention;

FIG. 11 is a schematic sectional view illustrating the configuration of the hydrogen production device included in the fuel-cell-system according to one embodiment of the present invention;

FIG. 12 is a schematic sectional view illustrating the configuration of the hydrogen production device included in the fuel-cell-system according to one embodiment of the present invention;

FIG. 13 is a schematic sectional view illustrating the configuration of the hydrogen production device included in the fuel-cell-system according to one embodiment of the present invention; and

FIG. 14 is a schematic sectional view of an alkaline fuel cell using an anion exchange membrane as a solid polymer electrolyte membrane.

### DESCRIPTION OF THE PREFERRED EMBODIMENTS

An anion-exchange-membrane fuel-cell-system according to the present invention includes: a fuel cell part; and a carbon dioxide eliminating part, wherein the fuel cell part includes a fuel electrode, an air electrode, an anion exchange solid polymer electrolyte membrane sandwiched between the fuel electrode and the air electrode, a fuel channel that supplies a fuel gas to the fuel electrode, and an air channel that supplies air or an oxygen gas to the air electrode, and the carbon dioxide eliminating part is configured to eliminate carbon dioxide which is mixed in the fuel gas when the fuel gas flows through the fuel channel, and to allow the fuel gas to flow again into the fuel channel after eliminating the carbon dioxide.

Preferably, the fuel-cell-system according to the present invention further includes a fuel gas supplying part that supplies a fuel gas to the fuel channel, and an air supplying part that supplies air or an oxygen gas to the air channel.

According to the configuration described above, the fuel gas can be supplied to the fuel electrode, while air or the oxygen gas can be supplied to the air electrode, whereby the fuel cell part can generate power.

Preferably, the fuel-cell-system according to the present invention further includes a gas mixer that mixes the fuel gas from which carbon dioxide is eliminated by the carbon dioxide eliminating part and the fuel gas supplied from the fuel gas supplying part, and supplies the resultant mixture to the fuel channel.

According to the configuration described above, the fuel gas from which carbon dioxide is eliminated by the carbon dioxide eliminating part can be supplied again to the fuel cell part, whereby a use efficiency of the fuel gas can be enhanced.

Preferably, the fuel-cell-system according to the present invention further includes a circulation channel provided so as to allow the fuel gas to flow from the fuel channel to the gas mixer, wherein the carbon dioxide eliminating part is provided to eliminate the carbon dioxide contained in the fuel gas flowing through the circulation channel.

According to the configuration described above, the fuel gas from which carbon dioxide is eliminated by the carbon dioxide eliminating part can be supplied again to the fuel cell part, whereby a use efficiency of the fuel gas can be enhanced.

Preferably, the fuel-cell-system according to the present invention further includes a humidity sensor that detects a humidity of the fuel gas flowing through the circulation channel or the humidity of the gas mixture formed by the gas mixer, wherein the gas mixer is configured to be capable of changing a mixture ratio of the fuel gas supplied from the circulation channel and the fuel gas supplied from the fuel gas supplying part based upon a signal from the humidity sensor.

According to the configuration described above, the gas mixer can mix the fuel gas containing moisture and supplied from the circulation channel, and the fuel gas supplied from the fuel gas supplying part, thereby being capable of supplying the gas mixture having an appropriate humidity to the fuel channel in the fuel cell part.

Preferably, the fuel-cell-system according to the present invention further includes a humidifying part that humidifies the fuel gas supplied to the fuel channel.

According to the configuration described above, the electric resistance of the solid polymer electrolyte membrane can be reduced, whereby the power generation efficiency of the fuel cell can be enhanced.

In the fuel-cell-system according to the present invention, it is preferable that the fuel gas is a hydrogen gas, and the fuel gas supplying part is a hydrogen supplying part.

This configuration can enhance the use efficiency of the fuel gas.

In the fuel-cell-system according to the present invention, it is preferable that the hydrogen supplying part includes a hydrogen storage part that is configured to store the hydrogen gas from which carbon dioxide is eliminated by the carbon dioxide eliminating part, and to supply the stored hydrogen gas to the gas mixer.

According to the configuration described above, when the operation of the fuel cell part is stopped, the hydrogen gas, which flows through a gas channel can be stored in the hydrogen storage part, whereby the hydrogen gas can efficiently be supplied to the fuel cell part. This configuration can also prevent the accumulation of the carbon dioxide into the hydrogen storage part.

Preferably, the fuel-cell-system according to the present invention further includes a dehumidifying part that dehumidifies the hydrogen gas that flowed through the fuel channel.

This configuration can prevent the hydrogen gas containing excessive moisture from being supplied to the fuel cell part, whereby the deterioration in the power generation efficiency of the fuel cell part due to a flooding phenomenon can be prevented.

In the fuel-cell-system according to the present invention, it is preferable that the dehumidifying part is configured to dehumidify the hydrogen gas to be stored in the hydrogen storage part.

This configuration can prevent water from being accumulated in the hydrogen storage part.

Preferably, the fuel-cell-system according to the present invention further includes a water electrolysis part that electrolytically generates a hydrogen gas and an oxygen gas, wherein the hydrogen storage part stores the hydrogen gas that is generated by the water electrolysis part and dehumidified by the dehumidifying part.

According to the configuration described above, the hydrogen gas generated by the water electrolysis part can be stored in the hydrogen storage part, and the stored hydrogen gas can be supplied to the fuel cell part. Accordingly, the hydrogen gas can be generated by a surplus power, and the fuel cell part can generate power by use of this hydrogen gas, when demands for electricity increases. Consequently, power can be supplied in accordance with the demand for the electricity. Since the hydrogen gas exhausted from the fuel cell part and the hydrogen gas generated by the water electrolysis part are dehumidified by the common dehumidifying part, the components of the system can be reduced, and the operating cost can be reduced.

Preferably, the fuel-cell-system according to the present invention further includes a photoelectric conversion part that is configured to output a photovoltaic power to the water electrolysis part.

This configuration can generate hydrogen by the photovoltaic power of the photoelectric conversion part.

In the fuel-cell-system according to the present invention, it is preferable that the photoelectric conversion part has a light acceptance surface and a back surface, and the water electrolysis part is provided on the back surface of the photoelectric conversion part, wherein the photoelectric conversion part and the water electrolysis part compose a hydrogen production device.

This configuration can shorten a wiring distance between the photoelectric conversion part and the water electrolysis part, thereby being capable of reducing an ohmic loss.

In the fuel-cell-system according to the present invention, it is preferable that the hydrogen production device includes a first electrolysis electrode and a second electrolysis electrode, which are respectively formed on the back surface of the photoelectric conversion part, wherein, when the light acceptance surface of the photoelectric conversion part is irradiated with light, and the first and second electrolysis electrodes are brought into contact with an electrolytic solution, the first and second electrolysis electrodes can electrolyze the electrolytic solution to generate a first gas and a second gas by utilizing the electromotive force generated by the photoelectric conversion part receiving light, one of the first and second gases being a hydrogen gas, and the other being an oxygen gas.

According to the configuration described above, the first and second electrolysis electrodes composing the hydrogen production device are configured to electrolyze the electrolytic solution to generate the first gas and the second gas by utilizing the electromotive force generated by the photoelectric conversion part receiving light. Accordingly, the first and second electrolysis electrodes can generate the first gas on the surface of the first electrolysis electrode, and the second gas on the surface of the second electrolysis electrode. Since the first and second electrolysis electrodes are formed on the back surface of the photoelectric conversion part, the light can enter the light acceptance surface without passing through the electrolytic solution, so that the incident light can be prevented from being absorbed and the incident light can be prevented from being scattered by the electrolytic solution. Thus, the incident light amount entering the photoelectric conversion part can be large, and the light use efficiency can be high. Since the first and second electrolysis electrodes are formed on the back surface of the photoelectric conversion part, the light entering the light acceptance surface is not absorbed or scattered by the first and second electrolysis electrodes, as well as by the first gas and the second gas generated from those electrodes, respectively. Thus, the incident light amount entering the photoelectric conversion part can be large, and the light use efficiency can be high.

In the fuel-cell-system according to the present invention, it is preferable that the photoelectric conversion part is configured to generate an electromotive force between the light acceptance surface and the back surface when being irradiated with light, the first electrolysis electrode is configured to be capable of being electrically connected to the back surface of the photoelectric conversion part, and the second electrolysis electrode is configured to be capable of being electrically connected to the light acceptance surface of the photoelectric conversion part.

According to the configuration described above, a stacked structure can be employed for the photoelectric conversion part included in the hydrogen production device.

In the fuel-cell-system according to the present invention, it is preferable that the hydrogen production device also includes an insulation part provided between the second electrolysis electrode and the back surface of the photoelectric conversion part.

This configuration can prevent a leak current from flowing between the second electrolysis electrode and the back surface of the photoelectric conversion part in the hydrogen production device.

In the fuel-cell-system according to the present invention, it is preferable that the hydrogen production device further includes a first electrode that is in contact with the light acceptance surface of the photoelectric conversion part.

This configuration can reduce an internal resistance in the hydrogen production device.

In the fuel-cell-system according to the present invention, it is preferable that the hydrogen production device further includes a first conductive part that electrically connects the first electrode and the second electrolysis electrode.

This configuration can allow the light acceptance surface of the photoelectric conversion part and the second electrolysis electrode to be electrically connected to each other.

In the fuel-cell-system according to the present invention, it is preferable that the first conductive part is formed in a contact hole penetrating the photoelectric conversion part.

This configuration can shorten the wiring distance between the light acceptance surface of the photoelectric conversion part and the second electrolysis electrode, thereby being capable of reducing the internal resistance.

In the fuel-cell-system according to the present invention, it is preferable that the insulation part is provided to cover the side face of the photoelectric conversion part, and the first conductive part is provided on a portion that is a part of the insulation part and that covers the side face of the photoelectric conversion part.

According to the configuration described above, the first conductive part can be provided with reduced steps, whereby the production cost can be reduced.

In the fuel-cell-system according to the present invention, it is preferable that the insulation part is provided to cover the side face of the photoelectric conversion part, and the second electrolysis electrode is provided on a portion that is a part of the insulation part and that covers the side face of the photoelectric conversion part, and is brought into contact with the first electrode.

This configuration can allow the first electrode and the second electrolysis electrode to be electrically connected without the formation of the first conductive part.

In the fuel-cell-system according to the present invention, it is preferable that the photoelectric conversion part has a photoelectric conversion layer formed of a p-type semiconductor layer, an i-type semiconductor layer, and an n-type semiconductor layer.

According to the configuration described above, the electromotive force can be generated by the light incidence into the photoelectric conversion part.

In the fuel-cell-system according to the present invention, it is preferable that the photoelectric conversion part generates a potential difference between first and second regions on the back surface of the photoelectric conversion part when being irradiated with light, wherein the first region is formed to be electrically connected to the first electrolysis electrode, while the second region is formed to be electrically connected to the second electrolysis electrode.

According to the configuration described above, the electromotive force generated between the first region and the second region can be outputted to the first electrolysis electrode and the second electrolysis electrode.

In the fuel-cell-system according to the present invention, it is preferable that the hydrogen production device further has an insulation part that is formed between the first and second electrolysis electrodes and the back surface of the photoelectric conversion part, and that has an opening on the first region and the second region.

According to the configuration described above, the electromotive force generated by the light incidence into the photoelectric conversion part can efficiently be generated between the first region and the second region.

In the fuel-cell-system according to the present invention, it is preferable that the photoelectric conversion part is formed of at least one semiconductor material having an n-type semiconductor part and a p-type semiconductor part, wherein one of the first and second regions is a part of the n-type semiconductor part, while the other is a part of the p-type semiconductor part.

According to the configuration described above, the electromotive force can be generated between the first region and the second region on the back surface of the photoelectric conversion part by the light incidence into the photoelectric conversion part.

In the fuel-cell-system according to the present invention, it is preferable that the hydrogen production device further has a translucent substrate, wherein the photoelectric conversion part is provided on the translucent substrate.

According to the configuration described above, the photoelectric conversion part can be formed on the translucent substrate.

In the fuel-cell-system according to the present invention, it is preferable that the photoelectric conversion part includes plural photoelectric conversion layers that are connected in series, wherein the plural photoelectric conversion layers supply the electromotive force generated by the light incidence into the photoelectric conversion part to the first electrolysis electrode and the second electrolysis electrode.

According to this configuration, the high-voltage electromotive force can easily be outputted to the first and second electrolysis electrodes.

In the fuel-cell-system according to the present invention, it is preferable that one of the first electrolysis electrode and the second electrolysis electrode is a hydrogen generation part generating H₂ from the electrolytic solution, while the other is an oxygen generation part generating O₂ from the electrolytic solution, wherein the hydrogen generation part and the oxygen generation part contain a hydrogen generation catalyst that is a catalyst for a reaction to generate H₂ from the electrolytic solution and an oxygen generation catalyst that is a catalyst for a reaction to generate O₂ from the electrolytic solution.

According to the configuration described above, the hydrogen production device can produce the hydrogen gas that is a fuel of the fuel cell part.

In the fuel-cell-system according to the present invention, it is preferable that at least one of the hydrogen generation part and the oxygen generation part has a catalytic surface area larger than an area of the light acceptance surface.

According to the configuration described above, hydrogen or oxygen can be more efficiently generated by the hydrogen production device.

In the fuel-cell-system according to the present invention, it is preferable that at least one of the hydrogen generation part and the oxygen generation part is preferably formed of a catalyst-supporting porous conductor.

According to the configuration described above, the catalytic surface area for the reaction to generate the hydrogen gas or the oxygen gas can be increased.

In the fuel-cell-system according to the present invention, it is preferable that the hydrogen generation part contains at least one of Pt, Ir, Ru, Pd, Rh, Au, Fe, Ni, and Se.

According to the configuration described above, the hydrogen gas can efficiently be generated from the electrolytic solution by the hydrogen production device.

In the fuel-cell-system according to the present invention, it is preferable that the oxygen generation part contains at least one of Mn, Ca, Zn, Co, and Ir.

According to the configuration described above, the oxygen gas can efficiently be generated from the electrolytic solution by the hydrogen production device.

In the fuel-cell-system according to the present invention, it is preferable that the hydrogen production device includes a translucent substrate, an electrolytic solution chamber, and a back substrate provided on the first electrolysis electrode and the second electrolysis electrode, wherein the photoelectric conversion part is provided on the translucent substrate, and the electrolytic solution chamber is provided between the first and second electrolysis electrodes and the back substrate.

According to the configuration described above, the surface of the first electrolysis electrode that can be in contact with the electrolytic solution and the surface of the second electrolysis electrode that can be in contact with the electrolytic solution can be formed to face the electrolytic solution chamber, whereby the first and second electrolysis electrodes can be brought into the electrolytic solution chamber.

In the fuel-cell-system according to the present invention, it is preferable that the hydrogen production device further includes a partition wall to separate the electrolytic solution chamber between the first electrolysis electrode and the back substrate, and the electrolytic solution chamber between the second electrolysis electrode and the back substrate.

According to the configuration described above, the first gas and the second gas can be separated by the partition wall.

In the fuel-cell-system according to the present invention, it is preferable that the partition wall includes an ion exchanger.

According to the configuration described above, an ion concentration imbalance generated in the electrolytic solution can easily be eliminated and become uniform.

Hereinafter, an embodiment of the present invention will be described with reference to the drawings. The configurations shown in the drawings and in the following description are just examples, and the scope of the present invention is not limited to those shown in the drawings and in the following description.

### Configuration of Anion-Exchange-Membrane Fuel-Cell-System

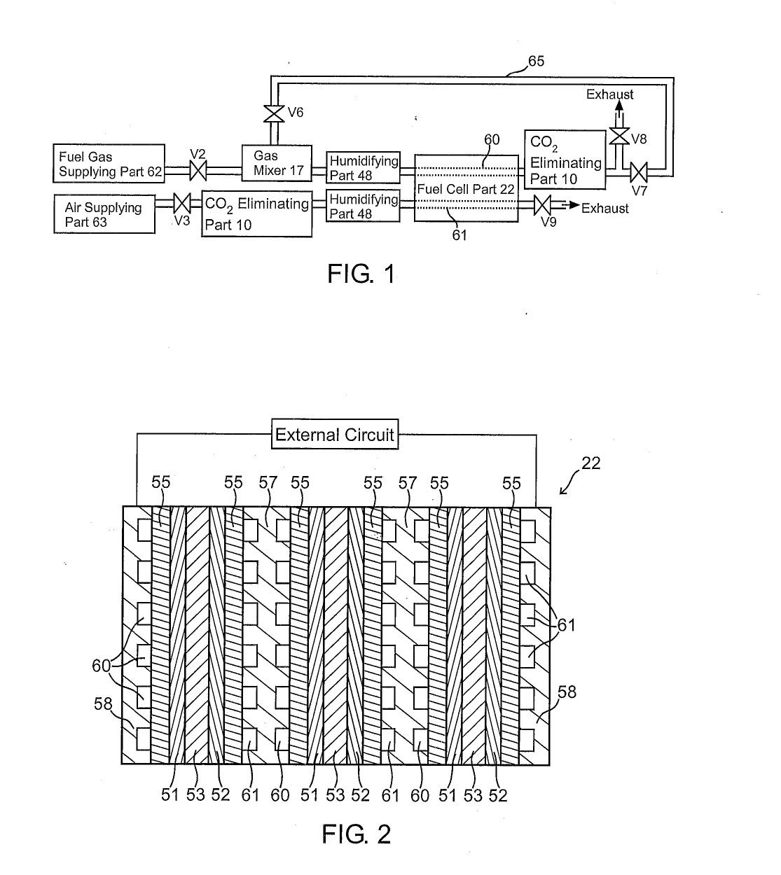

FIG. 1 is a schematic piping diagram of a fuel-cell-system according to an embodiment of the present invention, and FIG. 2 is a schematic sectional view of a fuel cell part included in the fuel-cell-system in FIG. 2 according to the embodiment of the present invention.

An anion-exchange-membrane fuel-cell-system according to the embodiment of the present invention includes: a fuel cell part 22; and a carbon dioxide eliminating part 10, wherein the fuel cell part 22 includes a fuel electrode 51, an air electrode 52, an anion exchange solid polymer electrolyte membrane 53 sandwiched between the fuel electrode 51 and the air electrode 52, a fuel channel 60 that supplies a fuel gas to the fuel electrode 51, and an air channel 61 that supplies air or an oxygen gas to the air electrode 52, and the carbon dioxide eliminating part 10 is configured to eliminate carbon dioxide which is mixed in the fuel gas when the fuel gas flows through the fuel channel 60, and to allow the fuel gas to flow again into the fuel channel 60 after eliminating the carbon dioxide.

The fuel-cell-system according to the present embodiment may also include a fuel gas supplying part 62, an air supplying part 63, a humidifying part 48, a gas mixer 17, and a circulation channel 65.

The fuel-cell-system according to the present embodiment may be a system using a hydrogen gas as a fuel gas.

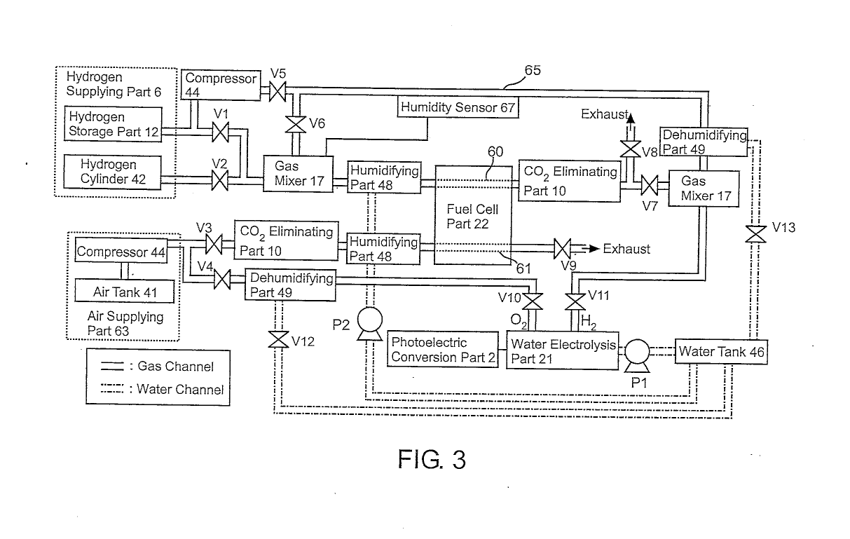

FIG. 3 is a schematic piping diagram of the fuel-cell-system according to the present embodiment.

The fuel-cell-system according to the present embodiment employing the hydrogen gas as the fuel gas may have a water electrolysis part 21, and a photoelectric conversion part 2 that can output a photovoltaic power to the water electrolysis part 21. The water electrolysis part 21 and the photoelectric conversion part 2 may compose a hydrogen production device 23.

The fuel-cell-system according to the present embodiment will be described below.

### 1. Fuel Cell Part, Fuel Gas Supplying Part, Air Supplying Part, Humidifying Part

The fuel cell part 22 includes the fuel electrode 51, the air electrode 52, the anion exchange solid polymer electrolyte membrane 53 sandwiched between the fuel electrode 51 and the air electrode 52, the fuel channel 60 that supplies the fuel gas to the fuel electrode 51, and the air channel 61 that supplies air or an oxygen gas to the air electrode 52.

The fuel gas supplying part 62 is provided to be capable of supplying the fuel gas to the fuel channel 60, while the air supplying part 63 is provided to be capable of supplying air or the oxygen gas to the air channel 61. The humidifying part 48 is provided to be capable of humidifying the fuel gas supplied to the fuel channel 60 or the air supplied to the air channel 61.

By virtue of this configuration, the humidified hydrogen can be supplied to the fuel electrode 51 in the fuel cell part 22, and the humidified air can be supplied to the air electrode 52. Therefore, the cell reaction described above can be progressed in the fuel electrode 51, the solid polymer electrolyte membrane 53, and the air electrode 52, whereby electric power can be extracted between the air electrode and the fuel electrode.

The fuel cell part 22 has a cross-section illustrated in FIG. 2, for example. Specifically, the fuel cell part 22 has a stacked body including the solid polymer electrolyte membrane 53 sandwiched between the fuel electrode 51 and the air electrode 52, and current collectors 55 provided on both ends thereof. The fuel cell part 22 illustrated in FIG. 2 has three stacked bodies described above. Each of the three stacked bodies is stacked through a separator 57 provided with the fuel channel 60 and the air channel 61, and connection plates 58 provided with the fuel channel 60 and the air channel 61 are stacked on both ends of the stacked bodies. The temperature of the fuel cell part 22 is increased to an operating temperature, the fuel gas is flown through the fuel channel 60, and air or oxygen gas is flown through the air channel 61, whereby the cell reaction progresses in each stacked body to cause an electromotive force. Accordingly, electric power can be outputted to an external circuit from the connection plates 58 on both sides. The number of the stacked bodies provided in the fuel cell part 22 can be changed according to the output of the fuel cell part 22.

The solid polymer electrolyte membrane 53 is an anion exchange type, and it is an anion conductive solid polymer electrolyte membrane having an anion as an ion conductive species. The solid polymer electrolyte membrane 53 may have a hydroxide ion (OH—) as the major ion conductive species. This can reduce an electric resistance ratio of the solid polymer electrolyte membrane 53, whereby the output of the fuel cell part 22 can be increased. The solid polymer electrolyte membrane 53 may contain a hydrocarbon anion exchange resin, for example. The solid polymer electrolyte membrane 53 may also be formed of a porous membrane having an anion exchanger on its surface. Preferable examples of the solid polymer electrolyte membrane 53 include a perfluorosulfonic acid solid polymer electrolyte membrane (anion exchange membrane), a styrene vinylbenzene solid polymer electrolyte membrane (anion exchange membrane), and a quaternary ammonium solid polymer electrolyte membrane (anion exchange membrane). The anion conductive solid oxide electrolyte membrane can be used as the solid polymer electrolyte membrane 53.

The fuel electrode 51 and the air electrode 52 can have a conductive carrier, and an electrode catalyst and an anion exchange resin carried on the surface of the conductive carrier. This can progress the above-mentioned electrode reaction on the surface of the electrode catalyst. Examples of the electrode catalyst include platinum, iron, cobalt, nickel, palladium, silver, ruthenium, iridium, molybdenum, manganese, a metal compound of these metals, and fine particles made of an alloy containing at least two or more of these metals. Preferably, the alloy contains at least two or more of platinum, iron, cobalt, and nickel. Examples of the alloy include platinum-iron alloy, platinum-cobalt alloy, iron-cobalt alloy, cobalt-nickel alloy, iron-nickel alloy, and iron-cobalt-nickel alloy.

Examples of the conductive carrier include a carbon black such as acetylene black, furnace black, channel black, or ketjen black, and a conductive carbon particle such as graphite or activated carbon. A carbon fiber such as vapor grown carbon fiber (VGCF), carbon nanotube, or carbon nanowire can also be used.

The current collector 55 can be formed as a porous layer having conductivity. Specifically, the current collector 55 can be an epoxy resin membrane or a porous metal containing a carbon paper, a carbon cloth, or carbon particle. The porous metal can be a foam or a sintered body of a metal or an alloy, or a fiber non-woven.

Each of the fuel channel 60 and the air channel 61 can be formed to have a gas supplying opening and a gas exhaust opening. The fuel gas is supplied to the fuel channel 60 from the gas supplying opening, while the fuel gas is exhausted from the fuel channel 60 from the gas exhaust opening. Air or the oxygen gas is supplied to the air channel 61 from the gas supplying opening, while the air or the oxygen gas is exhausted from the air channel 61 from the gas exhaust opening.

The fuel gas supplied to the fuel channel 60 of the fuel cell part 22 is, for example, a hydrogen gas, or a methanol gas.

The fuel gas supplying part 62 is to supply the fuel gas to the fuel channel 60 in the fuel cell part 22. When the fuel gas is the hydrogen gas, the fuel gas supplying part 62 (hydrogen supplying part 6) is a hydrogen cylinder, or a hydrogen pipe. The fuel gas supplying part 62 may also be a part that reforms a natural gas, propane, methanol, or gasoline, to generate the hydrogen gas. The fuel gas supplying part 62 may be a later-described water electrolysis part 21. In this case, the hydrogen gas generated by the water electrolysis part 21 can be supplied to the fuel channel 60 in the fuel cell part 22.

When the fuel gas supplying part 62 is the part that reforms the natural gas or others, it can include the carbon dioxide eliminating part. With this configuration, the carbon dioxide contained in the hydrogen gas can be eliminated from the fuel gas, before the fuel gas is supplied to the fuel channel 60, whereby the reduction in the output of the fuel cell part 22 due to the influence of the carbon dioxide can be prevented.

The case where the hydrogen gas is supplied to the fuel channel 60 in the fuel cell part 22 from a hydrogen tank 42, and the water electrolysis part 21 is not operated will be described with reference to FIG. 3. A valve V2 and a valve V6 are opened, while a valve V5 is closed, whereby the hydrogen gas from the hydrogen tank 42 and the hydrogen gas flowing through the circulation channel 65 are mixed by the gas mixer 17, and this gas mixture can be supplied to the fuel channel 60 in the fuel cell part 22. A valve V7 is opened, while a valve V8 and a valve V11 are closed, whereby the hydrogen gas, which flows through the fuel channel 60 and from which carbon dioxide is eliminated by the carbon dioxide eliminating part 10, can be flown through the circulation channel 65. The circulation of the hydrogen gas as described above can operate the fuel cell part 22 with the hydrogen gas supplied from the hydrogen tank 42 being used as the fuel, and with the unreacted fuel gas contained in the fuel gas that flowed through the fuel channel 60 being reused. When the use efficiency of hydrogen in the fuel channel 60 is high, only the hydrogen gas from the hydrogen tank 42 can be supplied to the fuel channel 60 without the circulation of the hydrogen gas by opening the valve V8 and closing the valve V7. The hydrogen gas flowing through the fuel channel 60 contains moisture caused by water generated due to the combustion of the hydrogen gas. This moisture can be supplied again to the fuel channel 60 by circulating the hydrogen gas by use of the circulation channel 65. Accordingly, the operating amount of the humidifying part 48 can be reduced.

Next, the case where the hydrogen gas is supplied to the fuel channel 60 from the hydrogen tank 42 and the water electrolysis part 21 will be described with reference to FIG. 3. The valve V7 and the valve V11 are opened, while the valve V8 is closed, whereby the hydrogen gas flowing through the fuel channel 60 and the hydrogen gas generated by the water electrolysis part 21 are mixed by the gas mixer 17, and this gas mixture can be supplied to the circulation channel 65. The valve V2 and the valve V6 are opened, while the valve V5 is closed, whereby the hydrogen gas from the hydrogen tank 42 and the hydrogen gas flowing through the circulation channel 65 are mixed by the gas mixer 17, and this gas mixture can be supplied to the fuel channel 60 in the fuel cell part 22. When the use efficiency of hydrogen in the fuel channel 60 is high, only the hydrogen gas generated by the water electrolysis part 21 can be supplied to the circulation channel 65 by opening the valve V8 and closing the valve V7. Since the hydrogen gas generated by the water electrolysis part 21 is directly supplied to the fuel channel 60 without being stored in the hydrogen storage part 12, it is unnecessary to eliminate the moisture caused by the electrolytic solution by the dehumidifying part 49. Since the moisture caused by the electrolytic solution can be supplied to the fuel channel 60, the operating amount of the humidifying part 48 can be reduced.

When the amount of the hydrogen gas generated by the water electrolysis part 21 is larger than the amount of the hydrogen gas used in the fuel cell part 22, the valve V2 may be closed so as to supply only the hydrogen gas flowing through the circulation channel 65 to the fuel channel 60.

The hydrogen supplying part 6 (fuel gas supplying part 62) can have the hydrogen storage part 12. The hydrogen storage part 12 can store hydrogen generated from the water electrolysis part 21, and can supply the stored hydrogen to the fuel channel 60 in the fuel cell part 22. For example, the hydrogen storage part 12 is a hydrogen tank, or hydrogen storage alloy. When the hydrogen storage part 12 is a hydrogen tank, the hydrogen generated from the water electrolysis part 21 is stored in the hydrogen tank as being compressed by a compressor 44. The hydrogen storage part 12 can be communicated with the circulation channel 65 that allows the unreacted hydrogen contained in the hydrogen flowing through the fuel channel 60 to be flown again through the fuel channel 60. By virtue of this configuration, when the fuel cell part 22 is stopped, the hydrogen remaining in the channel can be stored in the hydrogen storage part 12, whereby the hydrogen gas serving as the fuel gas can efficiently be utilized. By virtue of this configuration, it is unnecessary to always operate the fuel-cell-system. Consequently, the fuel-cell-system can respond to a variation in a load.

FIG. 3 illustrates the case in which the hydrogen supplying part 6 has both the hydrogen cylinder 42 and the hydrogen storage part 12. However, the hydrogen supplying part 6 may only have the hydrogen storage part 12. In this case, the hydrogen storage part 12 can store hydrogen from an external hydrogen pipe, and can supply the stored hydrogen to the fuel channel 60 in the fuel cell part 22.

When the fuel gas is a methanol gas, the fuel gas supplying part 62 is a tank storing methanol and a vaporizing device for vaporizing the methanol.

The air supplying part 63 is a part for supplying air or the oxygen gas to the air channel 61 in the fuel cell part 22. For example, it is an air cylinder, an oxygen cylinder, and an air compressor. The air supplying part 62 may be an oxygen tank that stores oxygen generated by the water electrolysis part 21, wherein the oxygen gas stored in the oxygen tank can be supplied to the air channel 61.

When air is supplied to the air channel 61, the carbon dioxide eliminating part 10 can be provided between the air supplying part 63 and the air channel 61 in order to prevent the reduction in the output from the fuel cell part 22 due to the carbon dioxide, since carbon dioxide of about 300 ppm is contained in air.

The humidifying part 48 can be provided to be capable of humidifying the fuel gas supplied to the fuel channel 60. The humidifying part 48 can also be provided to be capable of humidifying air or the oxygen gas supplied to the air supplying part 61. By virtue of this configuration, water required for the electrochemical reaction on the air electrode 52 can be supplied, or water can be supplied to the solid polymer electrolyte membrane 53, whereby the electric resistance ratio of the solid polymer electrolyte membrane 53 can be reduced, and the power generation efficiency can be enhanced. Examples of the humidifying part 48 include a bubbler humidifying system that bubbles gas to heated water, or a steam addition system for directly supplying steam to gas.

### 2. Carbon Dioxide Eliminating Part, Gas Mixer, Circulation Channel, Humidity Sensor

The carbon dioxide eliminating part 10 is to eliminate carbon dioxide in the gas. The carbon dioxide eliminating part 10 may be a part that eliminates carbon dioxide in the gas by dissolving carbon dioxide into an alkaline solution, or may be a part that eliminates carbon dioxide in the gas by adsorbing carbon dioxide to a porous adsorbent such as zeolite or activated carbon.

The carbon dioxide eliminating part 10 may be provided to eliminate carbon dioxide in the fuel gas (hydrogen gas) flowing through the fuel channel 60 in the fuel cell part 22, may be provided to eliminate carbon dioxide in air supplied to the air channel 61 in the fuel cell part 22, may be provided to eliminate carbon dioxide in hydrogen generated in a reformer, or may be provided to eliminate carbon dioxide in hydrogen remaining in the channel and to allow the resultant hydrogen into the hydrogen storage part 12, when the fuel cell unit 22 is stopped.

The carbon dioxide eliminating part 10 provided to eliminate carbon dioxide in the fuel gas that flowed through the fuel channel 60 in the fuel cell part 22 will be described here.

The fuel gas (hydrogen gas) supplied from the fuel gas supplying part 62 (hydrogen supplying part 6) flows through the fuel channel 60, wherein the hydrogen gas is supplied to the fuel electrode 51. On the fuel electrode 51, the hydrogen gas supplied from the fuel channel 60 and the hydroxide ion (OH—) supplied from the solid polymer electrolyte membrane 53 react to generate H₂O, whereby an electron is emitted to the fuel electrode 51. The generated H₂O flows through the fuel channel 60, and exhausted from the fuel cell part 22. The fuel gas that flowed through the fuel channel 60 and exhausted from the fuel cell part 22 contains hydrogen gas that is unreacted on the fuel electrode 51.

Carbon dioxide dissolved into the solid polymer electrolyte membrane 53 during the stop of the fuel cell part 22 or a small amount of carbon dioxide contained in air supplied to the air channel moves through the solid polymer electrolyte membrane 53 by an ion conduction as HCO₃—, and reacts on the fuel electrode 51 to generate CO₂. The generated CO₂ flows through the fuel channel 60, and is exhausted from the fuel cell part 22 together with the unreacted hydrogen gas.

Accordingly, when the fuel gas is the hydrogen gas, the fuel gas that flowed through the fuel channel 60, and is exhausted from the fuel cell part 22 contains the unreacted hydrogen gas, H₂O, and carbon dioxide. When the fuel gas is an organic compound such as methanol, the fuel gas exhausted from the fuel cell part 22 contains the unreacted fuel gas, CO₂ generated due to the reaction between the fuel gas and OH—, H₂O, and CO₂ exhausted from the solid polymer electrolyte membrane 53.

It is considered that the unreacted fuel gas contained in the fuel gas exhausted from the fuel cell part 22 is again supplied to the fuel channel 60 in the fuel cell part 22 so as to enhance use efficiency of the fuel gas. When the fuel gas exhausted from the fuel cell part 22 is again supplied to the fuel channel 60 as unchanged, the cell reaction can be caused by the unreacted fuel gas, whereby the use efficiency of the fuel gas can be enhanced. However, CO₂ is undesirably supplied to the fuel channel 60 together with the unreacted fuel gas. The CO₂ is dissolved into the solid polymer electrolyte membrane 53, or affects the cell reaction in the fuel electrode 51, which might cause the deterioration in the power generation efficiency of the fuel cell part 22. Further, CO₂ repeatedly flows through the fuel channel 60, so that CO₂ might be accumulated in the fuel gas flowing through the fuel channel 60.

In view of this, the carbon dioxide eliminating part 10 is provided in order to eliminate CO₂ contained in the fuel gas that flowed through the fuel channel 60 and to allow the fuel gas from which the CO₂ is eliminated to be flown again in the fuel channel 60. By virtue of this configuration, the fuel gas exhausted from the fuel cell part 22 can be supplied again to the fuel cell part 22 after CO₂ is eliminated, resulting in that the unreacted fuel gas from which CO₂ is eliminated can be supplied to the fuel cell part 22. Therefore, the reduction in the output of the fuel cell due to CO₂ can be suppressed, and the use efficiency of the fuel gas can be enhanced.

The carbon dioxide eliminating part 10 may be provided to eliminate CO₂ contained in the hydrogen gas stored in the hydrogen storage part 12. By virtue of this configuration, the hydrogen gas from which carbon dioxide is eliminated can be stored in the hydrogen storage part 12, which can prevent CO₂ from being accumulated in the hydrogen storage part 12.

More specifically, the circulation channel 65 that allows the gas exhaust opening of the fuel channel 60 in the fuel cell part 22 and the gas mixer 17 to communicate with each other can be provided. The CO₂ eliminating part 10 is provided on the circulation channel 65. The gas mixer 17 can be provided to mix the fuel gas supplied from the fuel gas supplying part 62 and the fuel gas supplied from the circulation channel 65 to generate a gas mixture, and to supply the gas mixture to the fuel channel 60 in the fuel cell part 22.

The gas mixer 17 can be provided with a check valve, a pressure-regulating valve, or a flow controller. The gas mixer 17 can also be provided to be capable of mixing gases, while preventing a flowback. Specifically, when there is a pressure difference between the fuel gas supplied from the fuel gas supplying part 62 and the fuel gas supplied from the circulation channel 65, a check valve is provided or a pressure-regulating valve is provided, in order to adjust the pressure of each gas. With this configuration, the gases can be mixed, while preventing the fuel gas supplied from one of the channels from flowing into the other channel, or without stopping the flow of the gas supplied from one of the channels. The gas mixer 17 can also be provided to mix the hydrogen gas generated by the water electrolysis part 21 and the fuel gas flowing through the fuel cell part 22.

The humidity sensor 67 can be provided to detect the humidity of the fuel gas flowing through the circulation channel 65 or the humidity of the gas mixture formed by the gas mixer 17. In this case, the gas mixer 17 may be provided to be capable of changing the mixture ratio of the fuel gas flowing through the circulation channel 65 and the fuel gas supplied from the fuel gas supplying part 62 based upon a signal from the humidity sensor 67. By virtue of this, the gas mixer 17 can mix the fuel gas that contains moisture and flows through the circulation channel and the fuel gas supplied from the fuel gas supplying part 62, and can supply the gas mixture having an appropriate humidity to the fuel channel 60 in the fuel cell part 22. As a result, the power consumption of the humidifying part 48 that humidifies the fuel gas supplied to the fuel channel 60 can be reduced, whereby the energy efficiency as the fuel-cell-system can be enhanced. When the fuel-cell-system has the dehumidifying part 49, the power consumption of the dehumidifying part 49 can also be reduced, whereby the energy efficiency as the fuel-cell-system can be enhanced.

The gas mixer 17 can change the mixture ratio of the fuel gas supplied from the circulation channel 65 and the fuel gas supplied from the fuel gas supplying part 62 according to the pressure regulation and flow control.

For example, when the gas mixer 17 mixes the hydrogen gas from the hydrogen cylinder included in the fuel gas supplying part 62 and the hydrogen gas flowing through the fuel cell part 22, the gas mixer 17 can adjust the mixture ratio of the gases by respectively adjusting the pressure/flow rate of the gases supplied from the respective channels. For example, the hydrogen gas flowing through the fuel cell part 22 contains a lot of water generated in the fuel cell part 22. In this case, the gas mixer 17 adjusts the mixture ratio of the hydrogen gas containing water and flowing through the fuel cell part and the hydrogen gas from the hydrogen cylinder not containing water, thereby being capable of adjusting the gas mixture to have an appropriate humidity without operating the humidifying part 48. When the mixture ratio of the gases can be adjusted as described above, the generated water generated in the fuel cell part 22 can be reused, so that it becomes unnecessary to operate the dehumidifying part 49.

The operating amount of the humidifying part 48 and the dehumidifying part 49 can be reduced by adjusting the ratio of the gas mixture as described above, whereby the efficiency as the system can be enhanced.

### 3. Dehumidifying Part

The dehumidifying part 49 can be provided to dehumidify the fuel gas that flowed through the fuel channel 60 in the fuel cell part 22. This configuration can eliminate moisture contained in the fuel gas that flowed through the fuel channel 60 in the fuel cell part 22, whereby the fuel gas from which the moisture is eliminated can be supplied again to the fuel channel 60. Accordingly, the supply of surplus moisture together with the fuel gas supplied to the fuel channel 60 can be prevented. Consequently, this configuration can prevent the deterioration in the power generation efficiency that is caused by the flooding phenomenon occurring on the fuel electrode 51.

The dehumidifying part 49 may be provided such that the fuel gas exhausted from the exhaust opening of the fuel channel 60 flows through the dehumidifying part 49 after it flows through the carbon dioxide eliminating part 10, or such that the fuel gas exhausted from the exhaust opening of the fuel channel 60 flows through the carbon dioxide eliminating part 10 after it flows through the dehumidifying part 49.

Examples of the dehumidifying part 49 include the one employing a cooling system for cooling a gas to a temperature not more than a dew-point temperature for dehumidification, the one employing a compression system for compressing a gas by a compressor for dehumidification, or the one employing an adsorption system for allowing a gas to pass through a solid that is easy to adsorb moisture.

The dehumidifying part 49 may be provided to dehumidify the hydrogen gas stored in the hydrogen storage part 12. This configuration can allow the hydrogen gas from which moisture is eliminated to be stored in the hydrogen storage part 12, and can prevent water from accumulating in the hydrogen storage part 12. The hydrogen gas stored in the hydrogen storage part 12 may be the hydrogen gas generated by the water electrolysis part 21.

The dehumidifying part 49 may be provided such that both the fuel gas that flowed through the fuel channel 60 in the fuel cell part 22, and the hydrogen gas generated by the water electrolysis part 21 and stored in the hydrogen storage part 12 are dehumidified by a common dehumidifying part 49. This configuration can reduce operating cost and production cost.

### 4. Water Electrolysis Part

The water electrolysis part 21 can electrolyze water to generate a hydrogen gas and an oxygen gas. The water electrolysis part 21 can be formed as an electrolysis vessel including the first electrolysis electrode 8 and the second electrolysis electrode 7. The electrolytic solution is stored in the electrolysis vessel, and a voltage is applied between the first and second electrolysis electrodes 8 and 7, whereby the electrolysis part 21 can electrolyze water contained in the electrolytic solution to generate the hydrogen gas and the oxygen gas. The water electrolysis part 21 may be a part of electrolyzing water by utilizing photovoltaic power of the photoelectric conversion part 2. In this case, the water electrolysis part 21 is provided to output the photovoltaic power of the photoelectric conversion part 2 to the first electrolysis electrode 8 and the second electrolysis electrode 7.

The water electrolysis part 21 can also be provided to store the generated hydrogen into the hydrogen storage part 12, or can also be provided to store the generated oxygen into the air tank. It can also be configured that the hydrogen and oxygen to be stored are stored after being dehumidified by the dehumidifying part 49.

The water electrolysis part 21 may be included in the hydrogen production device 23 described later. The first electrolysis electrode 8 and the second electrolysis electrode 7 in this case will be described later. The description of the first electrolysis electrode 8 and the second electrolysis electrode 7 included in the hydrogen production device 23 is applied to the description of the first electrolysis electrode 8 and the second electrolysis electrode 7 that are not included in the hydrogen production device 23, as long as there is no inconsistency.

The case where the hydrogen gas generated in the water electrolysis part 21 is stored in the hydrogen storage part 12, and the fuel cell part 22 is not operated will be described here with reference to FIG. 3. The hydrogen gas generated in the water electrolysis part 21 can be flown to the dehumidifying part 49 by opening the valve V11 and closing the valve V7. The dehumidifying part 49 eliminates moisture that is contained in the hydrogen gas and that results from the electrolytic solution, whereby the dried hydrogen flows through the circulation channel 65. The hydrogen gas flowing through the circulation channel is compressed by the compressor 44 to be stored in the hydrogen storage part 12 by opening the valve V5 and closing the valves V1 and V6. The hydrogen gas stored in the hydrogen storage part 12 can be supplied to the fuel channel 60 in the fuel cell part 22.

### 5. Photoelectric Conversion Part

The photoelectric conversion part 2 generates photovoltaic power when receiving sunlight. The photoelectric conversion part 2 can output the photovoltaic power to the water electrolysis part 21. Since the photovoltaic power from the photoelectric conversion part 2 is outputted to the water electrolysis part 21, water can be electrolyzed to generate a hydrogen gas and an oxygen gas by utilizing the photovoltaic power. Thus, the hydrogen gas can be generated by the photovoltaic power from the photoelectric conversion part 2. This hydrogen gas flows through the gas channel from the water electrolysis part 21, is dehumidified by the dehumidifying part 49, and then, can be stored in the hydrogen storage part 12.

The photoelectric conversion part 2 is not particularly limited, so long as it generates photovoltaic power when receiving light. Examples of the photoelectric conversion part include a photoelectric conversion part using a silicon semiconductor, a photoelectric conversion part using a compound semiconductor, a photoelectric conversion part using a dye sensitizer, or a photoelectric conversion part using an organic thin film.

The photoelectric conversion unit 2 may be included in the hydrogen production device 23 described later. The photoelectric conversion part 2 included in the hydrogen production device 23 will be described later. The description of the photoelectric conversion part 2 included in the hydrogen production device 23 is applied to the description of the photoelectric conversion part 2 that is not included in the hydrogen production device 23, as long as there is no inconsistency.

### 6. Hydrogen Production Device

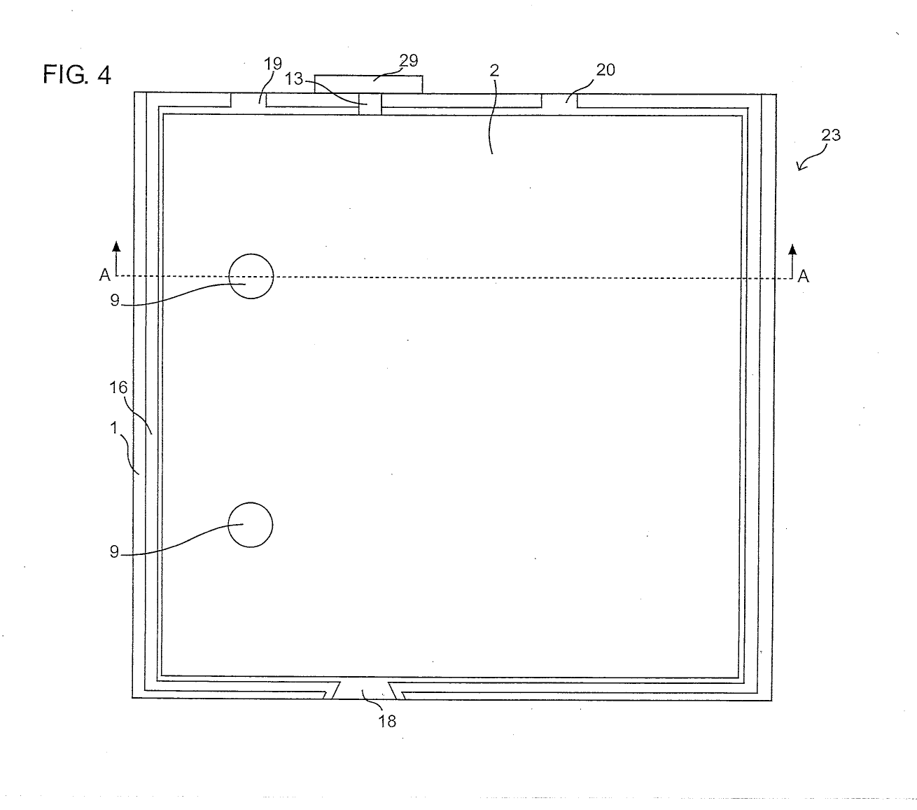

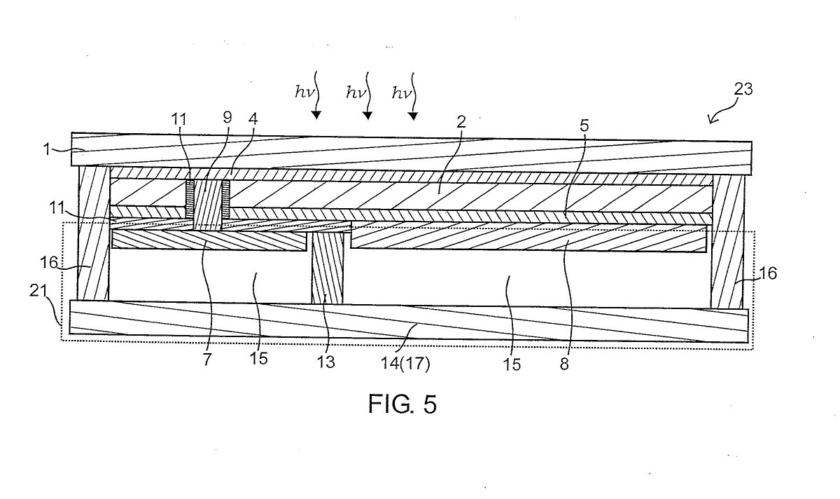

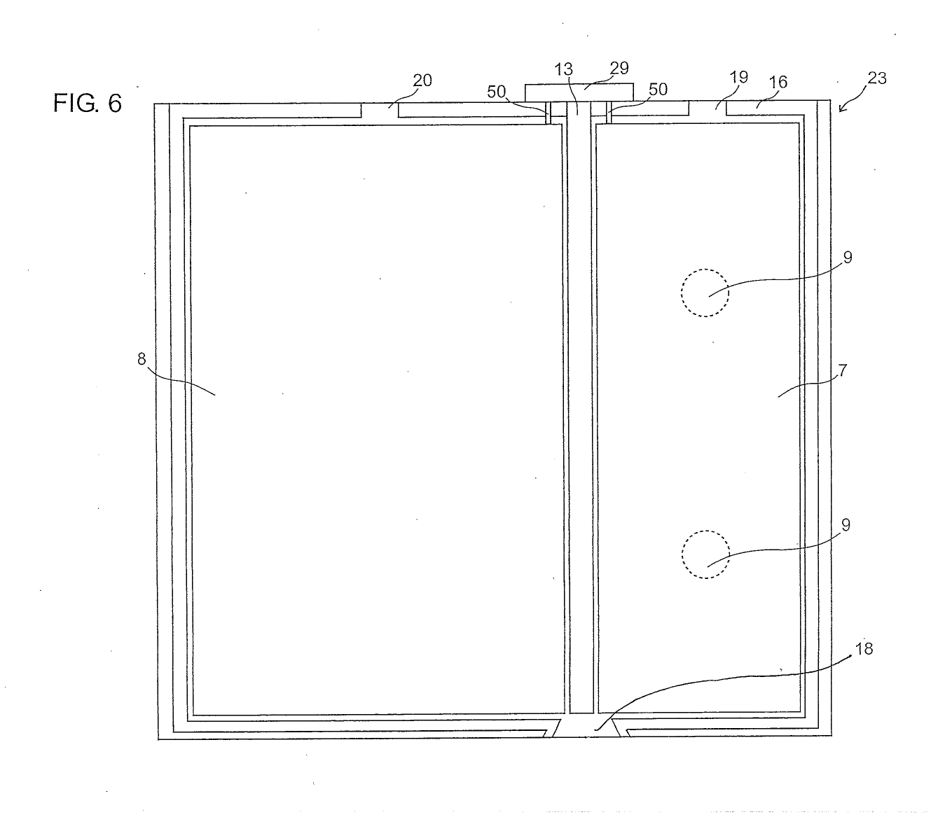

FIG. 4 is a schematic plan view illustrating the configuration of the hydrogen production device included in the fuel-cell-system according to the present embodiment, FIG. 5 is a schematic sectional view taken along a line A-A in FIG. 4, and FIG. 6 is a schematic back view illustrating the configuration of the hydrogen production device included in the fuel-cell-system according to the present embodiment.

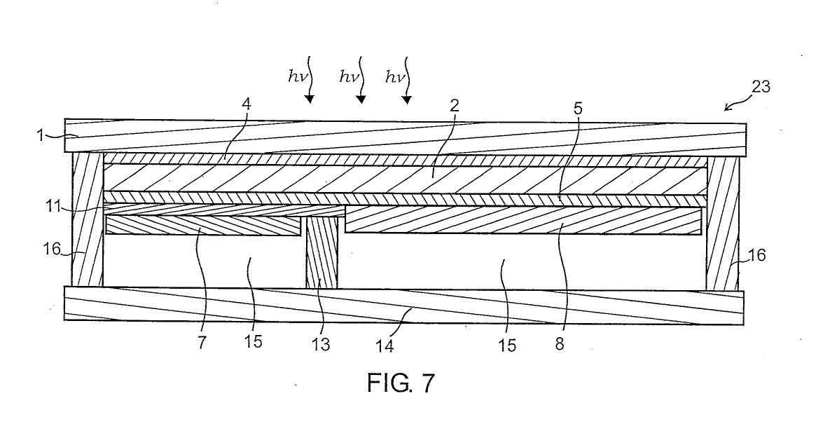

FIGS. 7 to 13 are schematic sectional views, each illustrating the configuration of the hydrogen production device included in the fuel-cell-system according to the present embodiment, and they are schematic sectional views corresponding to FIG. 5.

The hydrogen production device 23 can include the photoelectric conversion part 2 having a light acceptance surface and a back surface, and the water electrolysis part 21 provided on the back surface of the photoelectric conversion part 2.

The hydrogen production device 23 also includes the first electrolysis electrode 8 and the second electrolysis electrode 7 respectively provided on the back surface of the photoelectric conversion part 2. When sunlight is incident on the light acceptance surface of the photoelectric conversion part 2, and the first and second electrolysis electrodes 8 and 7 are brought into contact with the electrolytic solution, the first and second electrolysis electrodes 8 and 7 electrolyze the electrolytic solution to generate a first gas and a second gas by utilizing the electromotive force generated by the light incidence into the photoelectric conversion part 2. One of the first gas and the second gas is a hydrogen gas, and the other is an oxygen gas.

Since the first and second electrolysis electrodes 8 and 7 are provided to electrolyze the electrolytic solution to generate the first gas and the second gas respectively by utilizing the electromotive force generated by the light incidence into the photoelectric conversion part 2, the first gas can be generated on the surface of the first electrolysis electrode 8, while the second gas can be generated on the surface of the second electrolysis electrode 7. Since one of the first gas and the second gas is the hydrogen gas, the hydrogen gas can be produced.

Since the first electrolysis electrode 8 and the second electrolysis electrode 7 are provided on the back surface of the photoelectric conversion part 2, light can be incident on the light acceptance surface of the photoelectric conversion part 2 without passing through the electrolytic solution, so that the incident light can be prevented from being absorbed and the incident light can be prevented from being scattered by the electrolytic solution. Thus, the incident light amount entering the photoelectric conversion part 2 can be large, and the light use efficiency can be high.

Since the first and second electrolysis electrodes 8 and 7 are formed on the back surface of the photoelectric conversion part 2, the light entering the light acceptance surface is not absorbed or scattered by the first and second electrolysis electrodes 8 and 7, as well as by the first gas and the second gas generated from those electrodes, respectively. Thus, the incident light amount entering the photoelectric conversion part 2 can be large, and the light use efficiency can be high.

The hydrogen production device 23 can also include a translucent substrate 1, a first electrode 4, a second electrode 5, and a first conductive part 9.

The hydrogen production device 23 will be described below.

### 6-1. Translucent Substrate

The translucent substrate 1 may be provided in the hydrogen production device 23 in this embodiment. Further, the photoelectric conversion part 2 may be provided on the translucent substrate 1 with the light acceptance surface being on the side of the translucent substrate 1. In a case where the photoelectric conversion part 2 serves as a semiconductor substrate or the like and has certain strength, the translucent substrate 1 may not be provided. In a case where the photoelectric conversion part 2 can be formed on a flexible material such as a resin film, the translucent substrate 1 may not be provided.

Further, in order to receive sunlight on the light acceptance surface of the photoelectric conversion part 2, it is preferably transparent and has a high light transmittance but the light transmittance is not limited as long as it has such a structure that light can efficiently enter the photoelectric conversion part 2.

Substrate materials having a high light transmittance preferably include transparent rigid materials such as soda glass, quartz glass, Pyrex (registered trademark), and synthetic quartz plate, a transparent resin plate, and a film material. A glass substrate is preferably used because it is chemically and physically stable.

The surface of the translucent substrate 1 on the side of the photoelectric conversion part 2 may have a fine concavo-convex structure so that the incident light can be effectively irregularly reflected on the surface of the photoelectric conversion part 2. This fine concavo-convex structure can be formed by a well-known method such as a reactive ion etching (RIE) process or a blast process.

### 6-2. First Electrode

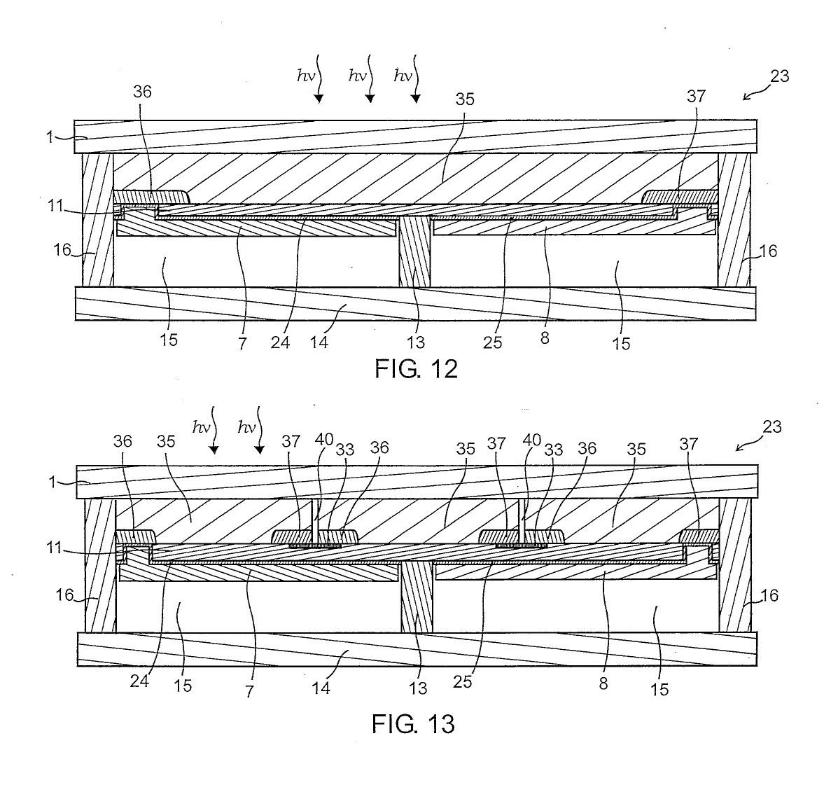

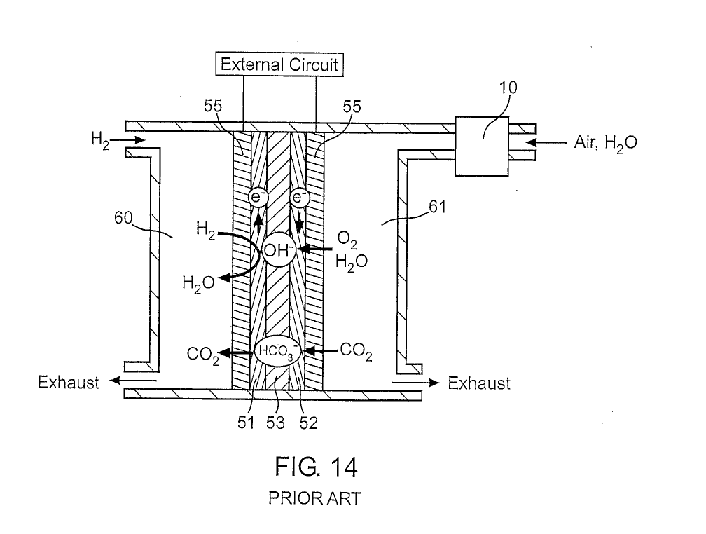

The first electrode 4 can be provided on the translucent substrate 1, and can be provided so as to be in contact with the light acceptance surface of the photoelectric conversion part 2. Alternatively, the first electrode 4 may have translucency. In a case where the translucent substrate 1 may not be provided, the first electrode 4 may be directly provided on the light acceptance surface of the photoelectric conversion part 2. The first electrode 4 can be electrically connected to the second electrolysis electrode 7. By providing the first electrode 4, a larger current flows between the light acceptance surface of the photoelectric conversion part 2 and the second electrolysis electrode 7. When the photoelectric conversion part 2 generates electromotive force between the first region and the second region on the back surface of the photoelectric conversion part 2 as illustrated in FIGS. 12 and 13, the first electrode 4 is unnecessary.

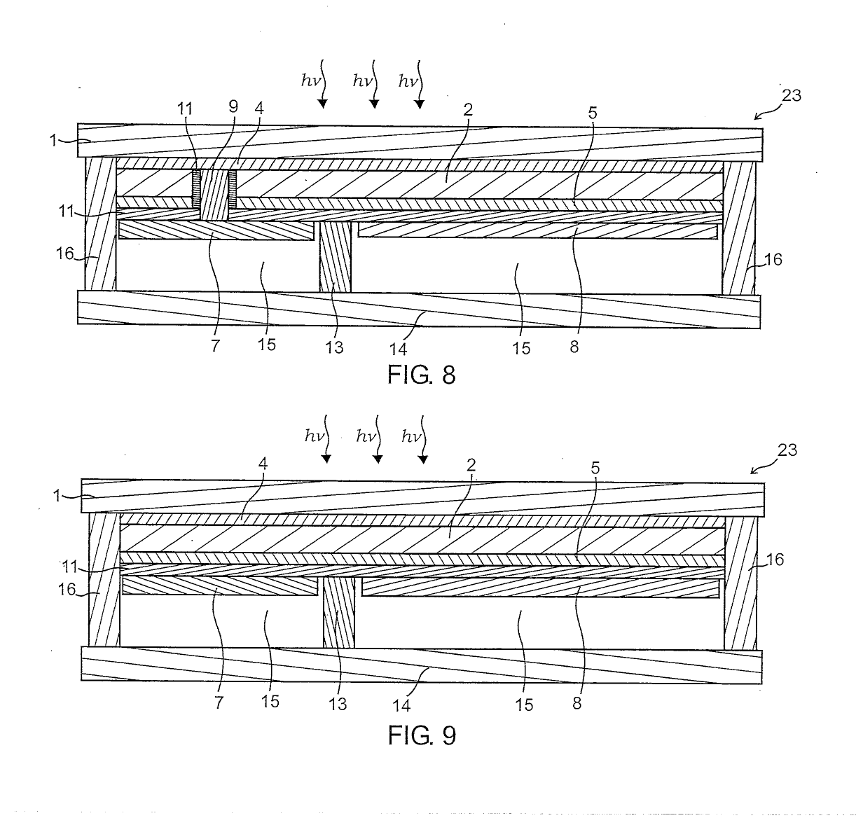

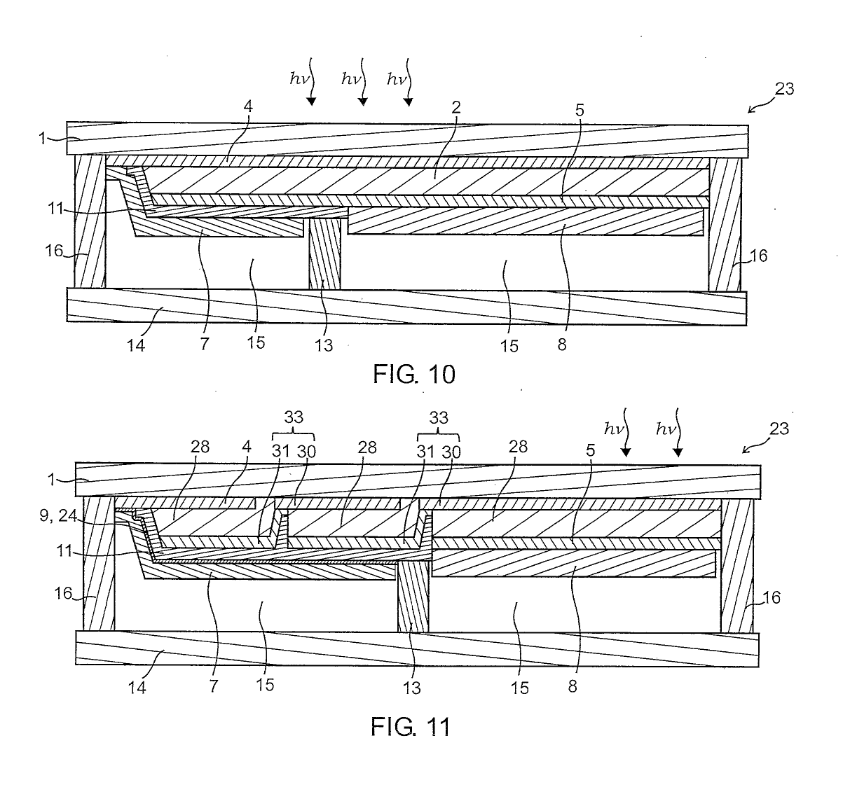

The first electrode 4 may be electrically connected to the second electrolysis electrode 7 via the first conductive part 9 as illustrated in FIGS. 5, 8, and 11, or may be in contact with the second electrolysis electrode 7 as illustrated in FIG. 10. The first electrode 4 can be electrically connected to the second electrolysis electrode 7 via a changeover part 29 and a wiring 50 as in the case in FIGS. 7 and 9.

The first electrode 4 may be formed of a transparent conductive film made of ITO or SnO₂, or may be formed of a finger electrode made of a metal such as Ag or Au.

Hereinafter, a description will be made of the case where the first electrode 4 is formed of the transparent conductive film.

The transparent conductive film is used to easily connect the light acceptance surface of the photoelectric conversion part 2 to the second electrolysis electrode 7.

Any material used as a transparent electrode in general can be used. More specifically, the transparent electrode may be made of In—Zn—O (IZO), In—Sn—O (ITO), ZnO—Al, Zn—Sn—O, or SnO₂. In addition, the transparent conductive film preferably has a sunlight transmittance of 85% or more, more preferably 90% or more, and most preferably 92% or more. In this case, the photoelectric conversion part 2 can efficiently absorb light.

The transparent conductive film may be formed in a well-known method such as the sputtering method, the vacuum deposition method, the sol-gel method, the cluster beam deposition method, or the PLD (Pulse Laser Deposition) method.

### 6-3. Photoelectric Conversion Part

The photoelectric conversion part 2 has the light acceptance surface and the back surface, and the first electrolysis electrode 8 and the second electrolysis electrode 7 are provided on the back surface of the photoelectric conversion part 2. The light acceptance surface receives the light to be photoelectrically converted, and the back surface is provided on the back of the light acceptance surface. The photoelectric conversion part 2 can be provided on the translucent substrate 1 via the first electrode 4 with the light acceptance surface facing downward. The photoelectric conversion part 2 may be the one generating the electromotive force between the light acceptance surface and the back surface as illustrated in FIGS. 5, and 7 to 11, or may be the one generating the electromotive force between the first region and the second region on the back surface of the photoelectric conversion part 2 as illustrated in FIGS. 12 and 13. The photoelectric conversion part 2 illustrated in FIGS. 12 and 13 can be formed of a semiconductor substrate having formed thereon an n-type semiconductor region 37 and a p-type semiconductor region 36.

The shape of the photoelectric conversion part 2 is not particularly limited. For example, the photoelectric conversion part 2 is formed to have a rectangular shape.

While the photoelectric conversion part 2 is not limited in particular as long as it can separate a charge by the incident light and generate the electromotive force, the photoelectric conversion part 2 may be a photoelectric conversion part using a silicon base semiconductor, a photoelectric conversion part using a compound semiconductor, a photoelectric conversion part using a dye sensitizer, or a photoelectric conversion part using an organic thin film.

When one of the first gas and the second gas is the hydrogen gas, and the other is the oxygen gas, the photoelectric conversion part 2 has to be made of a material which generates the electromotive force required for generating the hydrogen gas and the oxygen gas in the first electrolysis electrode 8 and the second electrolysis electrode 7, respectively, by receiving light. A potential difference between the first electrolysis electrode 8 and the second electrolysis electrode 7 needs to be more than a theoretic voltage (1.23 V) required for water decomposition, so that it is necessary to generate the sufficiently large potential difference in the photoelectric conversion part 2. Therefore, the photoelectric conversion part 2 is preferably provided such that the part to generate the electromotive force is formed of two or more junctions such as pn junctions connected in series. For example, the photoelectric conversion part 2 can be formed to have a structure in which photoelectric conversion layers, which are arranged side by side, are connected in series with a fourth conductive part 33 as illustrated in FIGS. 11 and 13.

Materials for the photoelectric conversion include materials provided based on a silicon base semiconductor, a compound semiconductor, and an organic material, and any photoelectric conversion material can be used. In addition, in order to increase the electromotive force, the above photoelectric conversion materials may be laminated. When photoelectric conversion materials are laminated, a multi-junction structure may be made of the same material. In a case where the plurality of photoelectric conversion layers having different optical bandgaps are laminated to complement low-sensitive wavelength regions of the photoelectric conversion layers to each other, the incident light can be efficiently absorbed over a large wavelength region. Each of the plural photoelectric conversion layers preferably has a different bandgap. By virtue of this configuration, the electromotive force generated in the photoelectric conversion part 2 can be increased more, whereby the electrolytic solution can more efficiently be electrolyzed.

In addition, in order to improve series connection characteristics among the photoelectric conversion layers, and in order to match photocurrents generated in the photoelectric conversion part 2, a conductor such as a transparent conductive film may be interposed between the layers. Thus, the photoelectric conversion part 2 can be prevented from deteriorating.

Hereinafter, examples of the photoelectric conversion part 2 will be described more specifically. It is noted that the photoelectric conversion part 2 may be provided by combining these examples. The photoelectric conversion part 2 described below can be formed as the photoelectric conversion layer, so long as there is consistency.

### 6-3-1. Photoelectric Conversion Part Using Silicon Base Semiconductor

The photoelectric conversion part 2 using the silicon base semiconductor may be of a monocrystalline type, a polycrystalline type, an amorphous type, a spherical silicon type, or a combination of those. A pn junction between a p-type semiconductor and an n-type semiconductor can be provided in any one of these types. Alternatively, a pin junction in which an i-type semiconductor is provided between the p-type semiconductor and the n-type semiconductor can be provided. Further alternatively, a plurality of pn junctions, a plurality of pin junctions, or the pn junction and pin junction may be provided.

The silicon base semiconductor is the semiconductor containing silicon series such as silicon, silicon carbide, or silicon germanium. In addition, it may include the one in which an n-type impurity or a p-type impurity is added to silicon, and may include a crystalline, amorphous, or microcrystalline semiconductor.

Alternatively, the photoelectric conversion part 2 using the silicon base semiconductor may be a thin-film or thick-film photoelectric conversion layer formed on the translucent substrate 1, the one in which the pn junction or the pin junction is formed on a wafer such as a silicon wafer, or the one in which the thin-film photoelectric conversion layer is formed on a wafer having the pn junction or the pin junction.

An example of a method for forming the photoelectric conversion part 2 using the silicon base semiconductor is shown below.

A first conductivity type semiconductor layer is formed on the first electrode 4 laminated on the translucent substrate 1 by a method such as a plasma CVD method. This first conductivity type semiconductor layer is a p+-type or n+-type amorphous Si thin film, or a polycrystalline or microcrystalline Si thin film doped such that a conductivity determining impurity atom concentration is 1×10¹⁸ to 5×10²¹/cm³. The material for the first conductivity type semiconductor layer is not limited to Si, and a compound such as SiC, SiGe, or SiₓO_{1-X} may be used.

A polycrystalline or microcrystalline Si thin film is formed as a crystalline Si base photoactive layer, on the first conductivity type semiconductor layer formed as described above by a method such as the plasma CVD method. In this case, the conductivity type is the first conductivity type whose doping concentration is lower than that of the first conductivity type semiconductor layer, or an i type. The material for the crystalline Si base photoactive layer is not limited to Si, and a compound such as SiC, SiGe, or SiₓO_{1-X} may be used.

Then, in order to form a semiconductor junction on the crystalline Si base photoactive layer, a second conductivity type semiconductor layer whose conductivity type is opposite to that of the first conductivity type semiconductor layer is formed by a method such as the plasma CVD method. This second conductivity type semiconductor layer is an n+-type or p+-type amorphous Si thin film, or a polycrystalline or microcrystalline Si thin film doped with a conductivity determining impurity atom with 1×10¹⁸ to 5×10²¹/cm³. The material for the second conductivity type semiconductor layer is not limited to Si, and a compound such as SiC, SiGe, or SiₓO_{1-X} may be used. In addition, in order to further improve the junction characteristics, a substantially i-type amorphous Si base thin film can be inserted between the crystalline Si base photoactive layer and the second conductivity type semiconductor layer. Thus, it is possible to laminate the photoelectric conversion layer which is closest to the light acceptance surface.

Then, a second photoelectric conversion layer is formed. The second photoelectric conversion layer is formed of a first conductivity type semiconductor layer, a crystalline Si base photoactive layer, and a second conductivity type semiconductor layer, and they are formed in the same manners correspondingly as the first conductivity type semiconductor layer, the crystalline Si base photoactive layer, and the second conductivity type semiconductor layer in the first photoelectric conversion layer. When the potential required for water decomposition cannot be sufficiently obtained with the two-layer tandem, it is preferable to provide three-layer or more laminated structure. Here, it is to be noted that a crystallization volume fraction of the crystalline Si base photoactive layer in the second photoelectric active layer is preferably higher than that of the crystalline Si base photoactive layer in the first layer. Similarly, when the three or more layers are laminated, its crystallization volume fraction is preferably higher than that of the lower layer. This is because absorption is high in a long-wavelength region, and spectral sensitivity is shifted to the long-wavelength region side, so that sensitivity can be improved over a large wavelength region even when the photoactive layer is made of the same Si material. That is, when the tandem structure is made of Si having different crystallinities, the spectral sensitivity becomes high, so that the light can be used with high efficiency. At this time, the material having a low crystallinity has to be provided on the side of the light acceptance surface to implement high light use efficiency. In addition, when the crystallinity is 40% or less, an amorphous component increases, and deterioration is generated.

An example of a method for forming the photoelectric conversion part 2 using the silicon substrate is shown below.

A monocrystalline silicon substrate or a polycrystalline silicon substrate can be used as the silicon substrate. The silicon substrate may be p-type, n-type, or i-type. An n-type impurity such as P is doped into a part of the silicon substrate with a thermal diffusion or ion implantation so as to form the n-type semiconductor part 37, while a p-type impurity such as B is doped into another part of the silicon substrate with the thermal diffusion or ion implantation so as to generate the p-type semiconductor part 36. With this, the pn junction, the pin junction, an npp+ junction, or an pnn+ junction can be formed on the silicon substrate, whereby the photoelectric conversion part 2 can be formed.

As illustrated in FIGS. 12 and 13, one n-type semiconductor part 37 and one p-type semiconductor part 36 can be formed on the silicon substrate, or one of the n-type semiconductor part 37 and the p-type semiconductor part 36 can be formed in plural numbers. As illustrated in FIG. 13, the silicon substrates, each having the n-type semiconductor part 37 and the p-type semiconductor part 36 formed thereon, are arranged side by side, and they are connected in series with the fourth conductive parts 33, whereby the photoelectric conversion part 2 can be formed.

The case where the silicon substrate is used has been described here. However, another semiconductor substrate that can form the pn junction, the pin junction, the npp+ junction, or the pnn+ junction may be used. The photoelectric conversion part 2 is not limited to have the semiconductor substrate, but may have a semiconductor layer formed on the substrate, so long as it can form the n-type semiconductor part 37 and the p-type semiconductor part 36.

### 6-3-2. Photoelectric Conversion Part Using Compound Semiconductor

As for the photoelectric conversion part using the compound semiconductor, for example, a pn junction is formed using GaP, GaAs, InP, or InAs formed of III-V group elements, CdTe/CdS formed of II-VI group elements, or CIGS (Copper Indium Gallium DiSelenide) formed of I-III-VI group elements.

A method for producing the photoelectric conversion part using the compound semiconductor is shown below as one example, and in this method, film forming processes and the like are all sequentially performed with an MOCVD (Metal Organic Chemical Vapor Deposition) device. As a material for the III group element, an organic metal such as trimethylgallium, trimethylaluminum, or trimethylindium is supplied to a growth system using hydrogen as a carrier gas. As a material for the V group element, a gas such as arsine (AsH₃), phosphine (PH₃), or stibine (SbH₃) is used. As a p-type impurity or n-type impurity dopant, diethylzinc or the like is used to make the p type, or silane (SiH₄), disilane (Si₂H₆), hydrogen selenide (H₂Se), or the like is used to make the n type. When the above raw material gas is supplied onto the substrate heated to 700° C. and pyrolyzed, a desired compound semiconductor material film can be epitaxially grown. A composition of the grown layer can be controlled by an introduced gas composition, and a film thickness thereof can be controlled by an introduction time length of the gas. When the photoelectric conversion part is provided as the multi-junction laminated layers, the grown layers can be excellent in crystalline property by matching lattice constants between the layers as much as possible, so that photoelectric conversion efficiency can be improved.

In order to enhance carrier collection efficiency, a well-known window layer may be provided on the side of the light acceptance surface or a well-known electric field layer may be provided on the side of a non-light acceptance surface, in addition to the part in which the pn junction is formed. In addition, a buffer layer may be provided to prevent the impurity from being diffused.

### 6-3-3. Photoelectric Conversion Part Using Dye Sensitizer

The photoelectric conversion part using the dye sensitizer is mainly formed of a porous semiconductor, a dye sensitizer, an electrolyte, and a solvent, for example.

As a material for the porous semiconductor, one kind or more can be selected from well-known semiconductors made of titanium oxide, tungsten oxide, zinc oxide, barium titanate, strontium titanate, cadmium sulfide, and the like. Methods for forming the porous semiconductor on the substrate include a method in which a paste containing semiconductor particles is applied by a method such as a screen printing method or an ink-jet method and is dried or baked, a method in which a film is formed by a method such as the CVD method using a raw material gas, a PVD method, a deposition method, a sputtering method, a sol-gel method, and a method using an electrochemical redox reaction.

As the dye sensitizer which is adsorbed to the porous semiconductor, various kinds of dyes which are absorbed to a visible light region and an infrared light region can be used. Here, in order to strongly adsorb the dye to the porous semiconductor, it is preferable that a dye molecule contains a group such as a carboxylic acid group, a carboxylic acid anhydride group, an alkoxy group, a sulfonic acid group, a hydroxyl group, a hydroxylalkyl group, an ester group, a mercapto group, or a phosphoryl group. These functional groups provide electric coupling to easily move an electron between an excited state dye and a conduction band of the porous semiconductor.

Dyes containing the functional groups include a ruthenium bipyridine series dye, quinone series dye, quinoneimine seriese dye, azo series dye, quinacridone series dye, squarylium series dye, cyanine series dye, merocyanine series dye, triphenylmethane series dye, xanthine series dye, porphyrin series dye, phthalocyanine series dye, perylene series dye, indigo series dye, and naphthalocyanine series dye.

Methods for adsorbing the dye to the porous semiconductor include a method in which the porous semiconductor is dipped in a solution including the dye dissolved therein (dye adsorbing solution). The solvents used in the dye adsorbing solution are not limited in particular as long as they can dissolve the dye, and more specifically include alcohol such as ethanol or methanol, ketone such as acetone, ether such as diethylether or tetrahydrofuran, a nitrogen compound such as acetonitrile, aliphatic hydrocarbon such as hexane, aromatic hydrocarbon such as benzene, ester such as ethyl acetate, and water.

The electrolyte is formed of a redox pair, and a liquid or a solid medium such as a polymer gel for holding the redox pair.

As the redox pair, a metal such as iron series or cobalt series, or a halogen substance such as chlorine, bromine, or iodine is preferably used, and a combination of metallic iodide such as lithium iodine, sodium iodine, or potassium iodine, and iodine is preferably used. Furthermore, an imidazole salt such as dimethyl-propyl-imidazole-iodide may be mixed therein.

As the solvent, while a carbonate compound such as propylene carbonate, a nitrile compound such as acetonitrile, alcohol such as ethanol or methanol, water, a polar aprotic substance, or the like is used, among them, the carbonate compound or the nitrile compound is preferably used.

### 6-3-4. Photoelectric Conversion Part Using Organic Thin Film

The photoelectric conversion part using the organic thin film may be an electron hole transport layer formed of an organic semiconductor material having an electron-donating property and an electron-accepting property, or lamination of an electron transport layer having the electron-accepting property and a hole transport layer having the electron-donating property.

While the organic semiconductor material having the electron-donating property is not limited in particular as long as it has a function as an electron donor, it is preferable that a film can be formed by a coating method, and especially, a conductive polymer having the electron-donating property is preferably used.

Here, the conductive polymer means a n-conjugated polymer formed of a π-conjugated system in which a double bond or triple bond containing carbon-carbon or a heteroatom is adjacent to a single bond alternately, while showing a semiconducting property.

The material for the conductive polymer having the electron-donating property may be polyphenylene, polyphenylenevinylene, polythiophene, polycarbazole, polyvinyl carbazole, polysilane, polyacetylene, polypyrrole, polyaniline, polyfluorene, polyvinyl pyrene, polyvinyl anthracene, a derivative or a copolymer thereof, a phthalocyanine-containing polymer, a carbazole-containing polymer, an organometallic polymer, or the like. Especially, a preferably used material may be tiophene-fluorene copolymer, polyalkyl thiophne, phenyleneethynylene-phenylenevinylene copolymer, fluorine-phenylene vinylene copolymer, tiophene-phenylenevinylene, or the like.

While the material for the organic semiconductor having the electron-accepting property is not limited in particular as long as it has a function as an electron acceptor, it is preferable that a film can be formed by a coating method and especially, a conductive polymer having the electron-donating property is preferably used.

As the conductive polymers having the electron-accepting property, it may be polyphenylenevinylene, polyfluorene, a derivative or a copolymer thereof, carbon nanotube, fullerene, a derivative thereof, a polymer containing a CN group or a CF₃ group, and a CF₃-substituted polymer thereof.

Alternatively, an organic semiconductor material having the electron-accepting property doped with an electron donating compound, or an organic semiconductor material having the electron-donating property doped with an electron accepting compound may be used. A material for the conductive polymer having the electron-accepting property doped with the electron donating compound may be the above-described conductive polymer material having the electron-accepting property. The electron donating compound to be doped may be a Lewis base such as an alkali metal or an alkali earth metal such as Li, K, Ca, or Cs. The Lewis base acts as the electron donor. In addition, the material for the conductive polymer having the electron-donating property doped with the electron accepting compound may be the above-described conductive polymer material having the electron-donating property. The electron accepting compound to be doped may be a Lewis acid such as FeCl₃, AlCl₃, AlBr₃, AsF₆, or a halogen compound. The Lewis acid acts as the electron acceptor.

While it is primarily assumed that the above photoelectric conversion part 2 receives sunlight and performs the photoelectric conversion, it can be irradiated, depending on applications, with artificial light such as light emitted from a fluorescent lamp, an incandescent lamp, an LED, or a specific heat source to perform the photoelectric conversion.

### 6-4. Second Electrode

The second electrode 5 can be provided on the back surface of the photoelectric conversion part 2. The second electrode 5 can also be provided between the back surface of the photoelectric conversion part 2 and the first electrolysis electrode 8, and between the back surface of the photoelectric conversion part 2 and the insulation part 11. The second electrode 5 can also electrically be connected to the first electrolysis electrode 8. By providing the second electrode 5, an ohmic loss between the back surface of the photoelectric conversion part 2 and the first electrolysis electrode 8 can be reduced. The second electrode 5 may also be in contact with the first electrolysis electrode 8. The second electrode 5 may electrically be connected to the first electrolysis electrode 8 via the changeover part 29 and the wiring 50.

It is preferable that the second electrode 5 has a corrosion resistance to the electrolytic solution, and a liquid shielding property to the electrolytic solution. This can prevent the corrosion of the photoelectric conversion part 2 by the electrolytic solution.

While the second electrode 5 is not limited in particular as long as it has conductivity, it may be a metal thin film, such as a thin film made of Al, Ag, or Au. The film can be formed by a sputtering method or the like. Alternatively, it may be a transparent conductive film made of a material such as In—Zn—O (IZO), In—Sn—O (ITO), ZnO—Al, Zn—Sn—O, or SnO₂.

### 6-5. First Conductive Part

The first conductive part 9 can be provided to be in contact with the first electrode 4 and the second electrolysis electrode 7 respectively. By providing the first conductive part 9, the first electrode 4 that is in contact with the light acceptance surface of the photoelectric conversion part 2 and the second electrolysis electrode 7 can easily electrically be connected.

As illustrated in FIGS. 5 and 8, the first conductive part 9 may be formed in a contact hole that penetrates the photoelectric conversion part 2. This structure can shorten the current path between the light acceptance surface of the photoelectric conversion part 2 and the second electrolysis electrode 7, whereby the first gas and the second gas can more efficiently be generated. The contact hole formed with the first conductive part 9 may be one or more, and it may have a circular cross-section.

The first conductive part 9 may be formed to cover the side face of the photoelectric conversion part 2 as illustrated in FIG. 11.

The material for the first conductive part 9 is not particularly limited, so long as it has conductivity. Methods for forming the first conductive part 9 include a method in which a paste containing semiconductor particles, e.g., a carbon paste or Ag paste, is applied by a method such as a screen printing method or an ink-jet method and is dried or baked, a method in which a film is formed by a method such as the CVD method using a raw material gas, a PVD method, a deposition method, a sputtering method, a sol-gel method, and a method using an electrochemical redox reaction.

### 6-6. Insulation Part

The insulation part 11 can be provided to prevent a generation of a leak current. For example, when the first conductive part 9 is formed in the contact hole penetrating the photoelectric conversion part 2 as illustrated in FIGS. 5 and 8, the insulation part 11 can be provided on the side wall of the contact hole.

The insulation part 11 can be provided between the second electrolysis electrode 7 and the back surface of the photoelectric conversion part 2 as illustrated in FIGS. 5 and 7 to 11. By virtue of this configuration, the generation of the leak current between the second electrolysis electrode 7 and the back surface of the photoelectric conversion part 2 can be prevented. When the photoelectric conversion part 2 generates a potential difference between the first region and the second region on the back surface of the photoelectric conversion part 2 when being irradiated with light as illustrated in FIGS. 12 and 13, the insulation part 11 can be provided between the first electrolysis electrode 8 and the back surface of the photoelectric conversion part 2, and between the second electrolysis electrode 7 and the back surface of the photoelectric conversion part 2, wherein the insulation part 11 may have an opening on the first region and the second region. By virtue of this configuration, electrons and holes, which are generated by the light incidence, can efficiently be separated from each other, whereby the photoelectric conversion efficiency can be more increased.

It is preferable that the insulation part 11 has a corrosion resistance to the electrolytic solution, and a liquid shielding property to the electrolytic solution. This can prevent the generation of the leak current, and can prevent the corrosion of the photoelectric conversion part 2 by the electrolytic solution.

The insulation part 11 can be made of either an organic material or an inorganic material, and the organic material may be an organic polymer such as polyamide, polyimide, polyarylene, an aromatic vinyl compound, a fluorine series polymer, an acrylic series polymer, or a vinyl amide series polymer, while the inorganic material may be a metal oxide such as Al₂O₃, SiO₂ such as a porous silica film, a fuluoridated silicon oxide film (FSG), SiOC, an HSQ (Hydrogen Silsesquioxane) film, SiN_{X}, or silanol (Si(OH)₄), which is dissolved in the solvent such as alcohol to be applied and heated to form a film.

A method for forming the insulation part 11 may be a method in which a paste containing an insulation material is applied by a screen printing method, inkjet method, or spin coating method and then dried or baked, a method in which a film is formed by a method such as the CVD method using a raw material gas, PVD method, deposition method, sputtering method, or sol-gel method.

### 6-7. Second Conductive Part, Third Conductive Part, Fourth Conductive Part

The second conductive part 24 and the third conductive part 25 can be provided between the insulation part 11 and the second electrolysis electrode 7, or between the insulation part 11 and the first electrolysis electrode 8. By providing the second conductive part 24 and the third conductive part 25, the electromotive force generated by the light incidence into the photoelectric conversion part 2 can efficiently be outputted to the first electrolysis electrode 8 or the second electrolysis electrode 7, and further, the ohmic loss can be reduced. The second conductive part 24 and the third conductive part 25 can be provided as illustrated in FIGS. 11 to 13, for example.

It is preferable that the second conductive part 24 and the third conductive part 25 have a corrosion resistance to the electrolytic solution, and a liquid shielding property to the electrolytic solution. This can prevent the increase in the ohmic resistance, and can prevent the corrosion of the photoelectric conversion part 2 by the electrolytic solution.

The fourth conductive part 33 can be provided to connect the photoelectric conversion layers in series as illustrated in FIGS. 11 and 13.

While the second conductive part 24, the third conductive part 25, or the fourth conductive part 33 is not limited in particular as long as it has conductivity, it may be a metal thin film, such as a thin film made of Al, Ag, or Au. The film can be formed by a sputtering method or the like. Alternatively, it may be a transparent conductive film made of a material such as In—Zn—O (IZO), In—Sn—O (ITO), ZnO—Al, Zn—Sn—O, or SnO₂.

### 6-8. First Electrolysis Electrode, Second Electrolysis Electrode

The first electrolysis electrode 8 and the second electrolysis electrode 7 are respectively provided on the back surface of the photoelectric conversion part 2. The first electrolysis electrode 8 and the second electrolysis electrode 7 respectively have a surface at the side of the back surface of the photoelectric conversion part 2, and a surface that is the reverse surface, and that can be in contact with the electrolytic solution. Thus, the first electrolysis electrode 8 and the second electrolysis electrode 7 do not block the light entering the photoelectric conversion part 2.

The first electrolysis electrode 8 and the second electrolysis electrode 7 are formed such that, when they are in contact with the electrolytic solution, they can electrolyze the electrolytic solution by utilizing the electromotive force generated by the light incidence into the photoelectric conversion part 2 so as to generate the first gas and the second gas respectively. For example, when the photoelectric conversion part 2 receives light to generate the electromotive force between the light acceptance surface and the back surface, the first electrolysis electrode 8 can electrically be connected to the back surface of the photoelectric conversion part 2, while the second electrolysis electrode 7 can electrically be connected to the light acceptance surface of the photoelectric conversion part 2, as illustrated in FIGS. 5 and 11. When the photoelectric conversion part 2 generates the electromotive force between the first region and the second region on its back surface by being irradiated with light, the first electrolysis electrode 8 can electrically be connected to either one of the first region and the second region, while the second electrolysis electrode 7 can electrically be connected to the other one of the first region and the second region, as illustrated in FIGS. 12 and 13.

When the first electrolysis electrode 8 is not in contact with the back surface of the photoelectric conversion part 2 or the second electrode 5 as illustrated in FIGS. 8 and 9, the first electrolysis electrode 8 can electrically be connected to the back surface of the photoelectric conversion part 2 via the changeover part 29. In the case illustrated in FIGS. 7 and 9, the second electrolysis electrode 7 can electrically be connected to the light acceptance surface of the photoelectric conversion part 2 via the changeover part 29.

At least one of the first electrolysis electrode 8 and the second electrolysis electrode 7 may be provided in plural numbers, and each of them may have a band-like surface that can be in contact with the electrolytic solution, wherein the first electrolysis electrode 8 and the second electrolysis electrode 7 may be alternately formed such that the long sides of the surfaces are adjacent to each other. By providing the first electrolysis electrode 8 and the second electrolysis electrode 7 as described above, the distance between the portion where the first gas is generated and the portion where the second gas is generated can be shortened, resulting in that an ion concentration imbalance generated in the electrolytic solution can be eliminated and become uniform. Since the surface that can be in contact with the electrolytic solution is formed to have a band-like shape, the first gas and the second gas can easily be collected.

It is preferable that the first electrolysis electrode 8 and the second electrolysis electrode 7 have a corrosion resistance to the electrolytic solution, and a liquid shielding property to the electrolytic solution. This can stably generate the first gas and the second gas, and can prevent the corrosion of the photoelectric conversion part 2 by the electrolytic solution. For example, a metal plate or a metal film having a corrosion resistance to the electrolytic solution can be employed for the first electrolysis electrode 8 and the second electrolysis electrode 7.

At least either one of the first electrolysis electrode 8 and the second electrolysis electrode 7 may preferably have a catalyst surface area larger than the area of the light acceptance surface of the photoelectric conversion part 2. By virtue of this configuration, the first gas and the second gas can more efficiently be generated by the electromotive force generated in the photoelectric conversion part 2.

In addition, at least either one of the first electrolysis electrode 8 and the second electrolysis electrode 7 may preferably be a catalyst-supporting porous conductor. In this case, the catalytic surface area of either one of the first electrolysis electrode 8 and the second electrolysis electrode 7 can increase, whereby the first gas and the second gas can more efficiently be generated. By using the porous conductor, the potential can be prevented from varying due to the current flowing between the photoelectric conversion part 2 and the catalyst, whereby the first gas and the second gas can more efficiently be generated. In this case, the first electrolysis electrode 8 or the second electrolysis electrode 7 can be formed to have a double-layer structure including a portion having a liquid shielding property to the electrolytic solution and a porous portion.

One of the first electrolysis electrode 8 and the second electrolysis electrode 7 may be a hydrogen generation part, and the other may be an oxygen generation part. In this case, one of the first gas and the second gas is a hydrogen gas, and the other is an oxygen gas.

### 6-9. Hydrogen Generation Part

The hydrogen generation part is the part to generate H₂ from the electrolytic solution, and it is the first electrolysis electrode 8 or the second electrolysis electrode 7. In addition, the hydrogen generation part may contain a catalyst for the reaction to generate H₂ from the electrolytic solution. In this case, the reaction rate to generate H₂ from the electrolytic solution can increase. The hydrogen generation part may be formed of only the catalyst for the reaction to generate H₂ from the electrolytic solution, and the catalyst may be supported by a carrier. In addition, the hydrogen generation part may have a catalytic surface area larger than the area of the light acceptance surface of the photoelectric conversion part 2. In this case, the reaction rate to generate H₂ from the electrolytic solution can become higher. In addition, the hydrogen generation part may be a catalyst-supporting porous conductor. In this case, the catalytic surface area can increase. In addition, the potential can be prevented from varying due to the current flowing between the light acceptance surface or the back surface of the photoelectric conversion part 2 and the catalyst contained in the hydrogen generation part. In addition, the hydrogen generation part may contain at least one of Pt, Ir, Ru, Pd, Rh, Au, Fe, Ni, and Se as a hydrogen generation catalyst. With this configuration, the hydrogen gas can be generated with higher reaction rate by the electromotive force generated in the photoelectric conversion part 2.

The catalyst for the reaction to generate H₂ from the electrolytic solution (hydrogen generation catalyst) is provided to promote conversion from two protons and two electrons to one hydrogen molecule, and can be made of a material which is chemically stable and having a small hydrogen generation overvoltage. Examples of the hydrogen generation catalyst include: a platinum group metal such as Pt, Ir, Ru, Pd, Rh, or Au having a catalytic activity for hydrogen, an alloy thereof, and a compound containing the platinum group metal; and an alloy containing any of metals such as Fe, Ni and Se constituting an activity center of a hydrogenase as a hydrogen generating enzyme, and a compound containing the metal, and these examples and combinations thereof can be desirably used as the hydrogen generation catalyst. Among them, Pt and a nanostructured body containing Pt are preferably used because their hydrogen generation overvoltage is low. A material such as CdS, CdSe, ZnS, or ZrO₂ which generate the hydrogen generation reaction by light irradiation can be also used.

The hydrogen generation catalyst can be supported on a conductor. As the conductor to support the catalyst, it may be a metal material, a carbonaceous material, or an inorganic material having conductivity.

The metal material is preferably a material having electron conductivity and having corrosion resistance under an acidic atmosphere. More specifically, the material may be a noble metal such as Au, Pt, or Pd, a metal such as Ti, Ta, W, Nb, Ni, Al, Cr, Ag, Cu, Zn, Su, or Si, a nitride and carbide of the above metal, a stainless steel, or an alloy such as Cu—Cr, Ni—Cr, or Ti—Pt. The metal material more preferably contains at least one element selected from a group including Pt, Ti, Au, Ag, Cu, Ni, and W because another chemical side reaction is hardly generated. This metal material is relatively low in electric resistance and can prevent a voltage from being lowered even when a current is drawn in a surface direction. In addition, when the metal material having poor corrosion resistance under the acidic atmosphere such as Cu, Ag, or Zn is used, a surface of the metal material having the poor corrosion resistance may be coated with a noble metal or metal having the corrosion resistance such as Au, Pt, or Pd, carbon, graphite, glassy carbon, a conductive polymer, conductive nitride, conductive carbide, or conductive oxide.

As the carbonaceous material, it is preferable that it is chemically stable and has conductivity. For example, the material may be carbon powder or carbon fiber such as acetylene black, vulcanized fiber, ketjen black, furnace black, VGCF, carbon nanotube, carbon nanohorn, or fullerene.

As the inorganic material having the conductivity, it may be In—Zn—O (IZO), In—Sn—O (ITO), ZnO—Al, Zn—Sn—O, SnO₂, or antimony oxide doped tin oxide.

In addition, as the conductive polymer, it may be polyacethylene, polythiophene, polyaniline, polypyrrole, polyparaphenylene, or polyparaphenylenevinylene, and as the conductive nitride, it may be carbon nitride, silicon nitride, gallium nitride, indium nitride, germanium nitride, titanium nitride, zirconium nitride, or thallium nitride, and as the conductive carbide, it may be tantalum carbide, silicon carbide, zirconium carbide, titanium carbide, molybdenum carbide, niobium carbide, iron carbide, nickel carbide, hafnium carbide, tungsten carbide, vanadium carbide, or chrome carbide, and as the conductive oxide, it may be tin oxide, indium tin oxide (ITO), or antimony oxide doped tin oxide.

A structure of the conductor to support the hydrogen generation catalyst may be preferably selected from a plate shape, foil shape, rod shape, mesh shape, lath plate shape, porous plate shape, porous rod shape, woven cloth shape, unwoven cloth shape, fiver shape, and a felt shape. In addition, the conductor having a groove formed by being pressed in a surface of a felt-shape electrode is preferably used because it can reduce electric resistance and flow resistance of an electrode liquid.

### 6-10. Oxygen Generation Part

The oxygen generation part is the part to generate O₂ from the electrolytic solution, and it is the first electrolysis electrode 8 or the second electrolysis electrode 7. In addition, the oxygen generation part may contain a catalyst for the reaction to generate O₂ from the electrolytic solution. In this case, the reaction rate to generate O₂ from the electrolytic solution can increase. The oxygen generation part may be formed of only the catalyst for the reaction to generate O₂ from the electrolytic solution, and the catalyst may be supported by a carrier. In addition, the oxygen generation part may have a catalytic surface area larger than the area of the light acceptance surface of the photoelectric conversion part 2. In this case, the reaction rate to generate O₂ from the electrolytic solution can increase. In addition, the oxygen generation part may be a catalyst-supporting porous conductor. Thus, the catalytic surface area can increase. In addition, the potential can be prevented from varying due to the current flowing between the light acceptance surface or the back surface of the photoelectric conversion part 2 and the catalyst contained in the oxygen generation part. Furthermore, the oxygen generation part may contain at least one of Mn, Ca, Zn, Co, and Ir, as an oxygen generation catalyst. With this configuration, the oxygen gas can be generated with higher reaction rate by the electromotive force generated in the photoelectric conversion part 2.

The catalyst for the reaction to generate O₂ from the electrolytic solution (oxygen generation catalyst) is provided to promote conversion from two water molecules to one oxygen, four protons and four electrons, and made of a material which is chemically stable and having a small oxygen generation overvoltage. For example, the materials include an oxide or compound containing Mn, Ca, Zn or Co serving as an active center of Photosystem II which is an enzyme to catalyze the reaction to generate oxygen from water using light, a compound containing a platinum group metal such as Pt, RuO₂, or IrO₂, an oxide or a compound containing a transition metal such as Ti, Zr, Nb, Ta, W, Ce, Fe, or Ni, and a combination of the above materials. Among them, an iridium oxide, manganese oxide, cobalt oxide, or cobalt phosphate is preferably used because an overvoltage is low and oxygen generation efficiency is high.

The oxygen generation catalyst can be supported on a conductor. As the conductors to support the catalyst, it may be a metal material, a carbonaceous material, or an inorganic material having conductivity. Their explanations are relevant to those described for the hydrogen generation part in “6-9. Hydrogen generation part” as long as there is no inconsistency.

When the catalytic activities of the single hydrogen generation catalyst and the single oxygen generation catalyst are small, an auxiliary catalyst may be used, such as an oxide of Ni, Cr, Rh, Mo, Co, or Se or a compound of them.

In addition, a method for supporting the hydrogen generation catalyst and the oxygen generation catalyst may be a method performed by directly applying it to the conductor or the semiconductor, a PVD method such as a vapor deposition method, sputtering method, or ion plating method, a dry coating method such as a CVD method, or an electro-crystallization method, depending on the material. A conductive substance can be supported between the photoelectric conversion part and the catalyst. In addition, when the catalytic activities for the hydrogen generation and the oxygen generation are not sufficient, the catalyst is supported on a porous body, a fibrous substance or a nanoparticle of metal or carbon, to increase the reaction surface area, whereby the hydrogen and oxygen generation rate can be improved.

### 6-11. Back Substrate

The back substrate 14 can be provided over the first electrolysis electrode 8 and the second electrolysis electrode 7 so as to be opposed to the translucent substrate 1.

In addition, the back substrate 14 can be provided such that a space is provided between the first electrolysis electrode 8 and the second electrolysis electrode 7, and the back substrate 14. This space can be formed as the electrolytic solution chamber 15. By introducing the electrolytic solution into the electrolytic solution chamber 15, the first electrolysis electrode 8 and the second electrolysis electrode 7 can be brought into contact with the electrolytic solution. When a box-like back substrate 14 is employed, the back substrate may be a bottom part of the box.

In addition, the back substrate 14 constitutes the electrolytic solution chamber 15 and is provided to confine the generated hydrogen and oxygen, so that it is made of a material having high air leakage efficiency. While the material is not limited to be transparent or opaque, it is preferably transparent because it can be observed that the first gas and the second gas are generated. The transparent back substrate is not limited in particular, and it may be a transparent rigid material such as quartz glass, Pyrex (registered trademark), or a synthetic quartz plate, a transparent resin plate, or a film material. Among them, the glass material is preferably used because it does not transmit a gas and it is stable chemically and physically.

### 6-12. Partition Wall

The partition wall 13 can be provided to separate the electrolytic solution chamber 15 that is a space between the first electrolysis electrode 8 and the back substrate 14, and the electrolytic solution chamber 15 that is a space between the second electrolysis electrode 7 and the back substrate 14. Thus, the first gas and the second gas generated in the first electrolysis electrode 8 and the second electrolysis electrode 7 are prevented from being mixed, so that the first gas and the second gas are separately collected.

In addition, the partition wall 13 may contain an ion exchanger. In this case, it can equalize an ion concentration which became unbalanced between the electrolytic solution in the space between the first electrolysis electrode 8 and the back substrate 14, and the electrolytic solution in the space between the second electrolysis electrode 7 and the back substrate 14.

The partition wall 13 may be an inorganic film made of porous glass, porous zirconia, or porous alumina, or an ion exchanger.

The ion exchange may be any well-known ion exchanger, such as a proton-conducting film, cation-exchanging film, or anion-exchanging film.

A material for the proton-conducting film is not limited in particular as long as it has proton-conducting and electrically insulating properties, such as a polymer film, inorganic film, or composite film.

The polymer film may be a perfluoro sulfonate series electrolytic film such as Nafion (registered trademark) made by Du Pont, Aciplex (registered trademark) made by Asahi Kasei Corporation, or Flemion (registered trademark) made by Asahi Glass Co., Ltd., or a carbon hydride series electrolytic film formed of polystyrene sulfonate, sulfonated polyether ether ketone, or the like.

The inorganic film may be a film made of glass phosphate, cesium hydrogen sulfate, polytungsto phosphate, ammonium polyphosphate, or the like. The composite film is formed of an inorganic substance such as a sulfonated polyimide series polymer, or tungsten acid, and an organic substance such as polyimide, and more particularly, GORE-SELECT (registered trademark) made by Gore & Associates Inc., a pore-filling electrolytic film, or the like. Furthermore, when it is used in a high-temperature atmosphere (such as 100° C. or more), the material may be sulfonated polyimide, 2-acrylamide-2-methylpropane sulfonate (AMPS), sulfonated polybenzimidazole, phosphonated polybenzimidazole, cesium hydrogen sulfate, ammonium polyphosphate, or the like.

The cation-exchanging film may be a solid polymer electrolyte which can move cation. More specifically, it may be a fluorine series ion-exchanging film such as a perfluoro carbon sulfonate film or perfluoro carbon carboxylic acid film, a poly-benz-imidazole film impregnated with phosphoric acid, a polystyrene sulfonate film, a sulfonated styrene-vinylbenzene copolymer film, or the like.

When an anion transport number in the support electrolytic solution is high, the anion-exchanging film is preferably used. As the anion-exchanging film, a solid polymer electrolyte which can move anion can be used. More specifically, it may be a polyortho phenylenediamine film, a fluorine series ion-exchanging film having an ammonium salt derivative group, a vinylbenzene polymer film having an ammonium salt derivative group, a film aminated with chloromethylstyrene-vinylbenzene copolymer, or the like.

### 6-13. Seal Material

The seal material 16 is the material to bond the translucent substrate 1 and the back substrate 14, and to seal the electrolytic solution flowing in the hydrogen production device 23, and the first gas and the second gas generated in the hydrogen production device 23. When the box-like back substrate 14 is employed, the seal material 16 is used to bond the box and the translucent substrate 1. The seal material 16 is preferably an ultraviolet curing adhesive or a thermal curing adhesive, but its kind is not limited. The ultraviolet curing adhesive is a resin which polymerizes by being irradiated with a light having a wavelength of 200 to 400 nm and cures in several seconds after being irradiated, and is divided into a radical polymerization type and a cation polymerization type, and the radical polymerization type resin is formed of acrylate or unsaturated polyester, and the cation polymerization type is formed of epoxy, oxetane, or vinyl ether. In addition, the thermal curing polymer adhesive may be an organic resin such as a phenol resin, epoxy resin, melamine resin, urea resin, or thermal curing polyimide. The thermal curing polymer adhesive successfully bonds the members by being heated and polymerizing under a pressed condition at the time of thermal compression and then being cooled down to room temperature while kept being pressed, so that a fastening member is not needed. In addition to the organic resin, a hybrid material having high adhesion to the glass substrate can be used. By using the hybrid material, mechanical characteristics such as elasticity and hardness are improved, and thermal resistance and chemical resistance can be considerably improved. The hybrid material is formed of inorganic colloidal particles and an organic binder resin. For example, it is formed of the inorganic colloidal particles such as silica, and the organic binder resin such as an epoxy resin, polyurethane acrylate resin, or polyester acrylate resin.

Here, the seal material 16 is shown, but this is not limited as long as it has a function to bond the translucent substrate 1 and the back substrate 14, so that a method in which physical pressure is applied from the outside with a member such as a screw using a resin or metal gasket may be occasionally used to enhance the air tightness.

### 6-14. Electrolytic Solution Chamber

The electrolytic solution chamber 15 can be the space between the first electrolysis electrode 8 and the back substrate 14, and the space between the second electrolysis electrode 7 and the back substrate 14. In addition, the electrolytic solution chamber 15 can be separated by the partition wall 13.

### 6-15. Water Intake

The water intake 18 can be provided by opening a part of the seal material 16 in the hydrogen production device 23 or by opening a part of the back substrate 14. The water intake 18 is arranged to supply the electrolytic solution to be converted to the first gas and the second gas, and its position and shape are not limited in particular as long as the electrolytic solution as a raw material can be efficiently supplied to the hydrogen production device 23.

### 6-16. First Gas Exhaust Opening, and Second Gas Exhaust Opening

The first gas exhaust opening 20 and the second gas exhaust opening 19 are formed to be very close to the end of the first electrolysis electrode 8 and the end of the second electrolysis electrode 7 respectively. By virtue of this configuration, the first gas can be collected from the first gas exhaust opening 20, while the second gas can be collected from the second gas exhaust opening 19.

When the hydrogen production device 23 is arranged in such a manner that the light acceptance surface of the photoelectric conversion part 2 tilts with respect to the horizontal surface, the first gas exhaust opening 20 can be formed to be very close to the upper end of the surface of the first electrolysis electrode 8 that can be in contact with the electrolytic solution. When the hydrogen production device 23 is arranged in such a manner that the light acceptance surface of the photoelectric conversion part 2 tilts with respect to the horizontal surface, the second gas exhaust opening 19 can be formed to be very close to the upper end of the surface of the second electrolysis electrode 7 that can be in contact with the electrolytic solution. By virtue of this configuration, when the hydrogen production device 23 is arranged in such a manner that the light acceptance surface of the photoelectric conversion part 2 tilts with respect to the horizontal surface so as to allow the sunlight to be incident on the light acceptance surface, the first gas generated in the first electrolysis electrode 8 rises in the electrolytic solution in the form of bubbles, and can be collected from the first gas exhaust opening 20, while the second gas generated in the second electrolysis electrode 7 rises in the electrolytic solution in the form of bubbles, and can be collected from the second gas exhaust opening 19.

The first gas exhaust opening 20 and the second gas exhaust opening 19 can be provided by forming an opening on the seal material 16, for example. An inflow prevention valve may be provided in order to prevent the electrolytic solution from flowing into the first gas exhaust opening 20 and the second gas exhaust opening 19.

The first gas exhaust opening 20 can communicate with a first gas exhaust path, while the second gas exhaust opening 19 can communicate with a second gas exhaust path. The first gas exhaust path can communicate with the plural first gas exhaust openings 20, while the second gas exhaust path can communicate with the plural second gas exhaust openings 19. With this configuration, the first gas and the second gas generated in the hydrogen production device 23 can be collected. The first gas exhaust path and the second gas exhaust path can be connected to the hydrogen storage part 12. By virtue of this configuration, the hydrogen gas generated in the hydrogen production device 23 can be stored in the hydrogen storage part 12. One of the first gas exhaust path and the second gas exhaust path can compose a gas channel through which hydrogen flows, and the other can compose a gas channel through which air flows.

### 6-17. Electrolytic Solution

The electrolytic solution is not particularly limited, so long as it is a raw material of the first gas and the second gas. The electrolytic solution is the water solution containing the electrolyte such as an electrolytic solution containing 0.1M of H₂SO₄, or a buffering solution containing 0.1 M of potassium phosphate. In this case, a hydrogen gas and an oxygen gas can be produced from the electrolytic solution as the first as and the second gas.

### 7. Water Channel

A water channel can be provided to allow the humidifying part 48, the dehumidifying part 49, and the water electrolysis part 21 to communicate with the water tank 46. The water channel can be provided with a pump or a valve for circulating water.

The water channel can be provided as illustrated in FIG. 3, for example. With reference to FIG. 3, the decrease in the electrolytic solution in the water electrolysis part 21 can be prevented by supplying water stored in the water tank 46 to the water electrolysis part 21 by a pump P1. The valves V12 and V13 are opened, whereby the water separated by the dehumidifying part 49 can be collected into the water tank 46. Water in the water tank 46 can be supplied to the humidifying part 48 by the pump P2.

Thus, the water electrolysis part 21 or the humidifying part 48 can use the water separated by the dehumidifying part 49, whereby water can effectively be utilized.

### 8. Changeover Part

The changeover part 29 can switch a circuit that outputs the electromotive force generated by the light incidence into the photoelectric conversion part 2 to a first external circuit, and a circuit that outputs the electromotive force generated by the light incidence into the photoelectric conversion part 2 to the first electrolysis electrode 8 and the second electrolysis electrode 7, and generates the first gas and the second gas from the electrolytic solution. Thus, the electromotive force generated by the light incidence into the photoelectric conversion part 2 to the first external circuit as power, and the first gas and the second gas can be produced by using the electromotive force generated by the light incidence into the photoelectric conversion part 2.

The method of electrically connecting the changeover part 29 and the first external circuit is not particularly limited. For example, the changeover part 29 may have an output terminal, and the changeover part 29 may electrically be connected to the first external circuit via the output terminal.

The changeover part 29 can electrically be connected to the second external circuit, and can switch to a circuit that outputs the electromotive force inputted from the second external circuit to the first electrolysis electrode 8 and the second electrolysis electrode 7, and generates the first gas and the second gas from the electrolytic solution.

Thus, the first gas and the second gas can be produced from the electrolytic solution by utilizing the electromotive force inputted from the second external circuit.

The method of electrically connecting the changeover part 29 and the second external circuit is not particularly limited. For example, the changeover part 29 may have an input terminal, and the changeover part 29 may electrically be connected to the second external circuit via the input terminal.

What is claimed is:

1. An anion-exchange-membrane type of fuel-cell-system, comprising:
a fuel cell part; and
a carbon dioxide eliminating part, wherein
the fuel cell part comprises a fuel electrode, an air electrode, an anion-exchange type of solid polymer electrolyte membrane sandwiched between the fuel electrode and the air electrode, a fuel channel that supplies a fuel gas to the fuel electrode, and an air channel that supplies air or an oxygen gas to the air electrode, and
the carbon dioxide eliminating part is configured to eliminate carbon dioxide which is mixed in the fuel gas when the fuel gas flows through the fuel channel, and to allow the fuel gas to flow again in the fuel channel after eliminating the carbon dioxide.

2. The fuel-cell-system according to claim 1, further comprising a fuel gas supplying part that supplies a fuel gas to the fuel channel, and an air supplying part that supplies air or an oxygen gas to the air channel.

3. The fuel-cell-system according to claim 2, further comprising a gas mixer that mixes the fuel gas from which carbon dioxide is eliminated by the carbon dioxide eliminating part and the fuel gas supplied from the fuel gas supplying part, and supplies the resultant mixture to the fuel channel.

4. The fuel-cell-system according to claim 3, further comprising a circulation channel provided so as to allow the fuel gas to flow from the fuel channel to the gas mixer, wherein the carbon dioxide eliminating part is provided to eliminate carbon dioxide contained in the fuel gas flowing through the circulation channel.

5. The fuel-cell-system according to claim 4, further comprising a humidity sensor that detects a humidity of the fuel gas flowing through the circulation channel or the humidity of the gas mixture formed by the gas mixer, wherein the gas mixer is configured to be capable of changing a mixture ratio of the fuel gas supplied from the circulation channel and the fuel gas supplied from the fuel gas supplying part based upon a signal from the humidity sensor.

6. The fuel-cell-system according to claim 3, further comprising a humidifying part that humidifies the fuel gas supplied to the fuel channel.

7. The fuel-cell-system according to claim 3, wherein the fuel gas is a hydrogen gas, and the fuel gas supplying part is a hydrogen supplying part.

8. The fuel-cell-system according to claim 7, wherein the hydrogen supplying part includes a hydrogen storage part that is configured to store the hydrogen gas from which carbon dioxide is eliminated by the carbon dioxide eliminating part, and to supply the stored hydrogen gas to the gas mixer.

9. The fuel-cell-system according to claim 8, further comprising a dehumidifying part that dehumidifies the hydrogen gas that flowed through the fuel channel.

10. The fuel-cell-system according to claim 9, the dehumidifying part is configured to dehumidify the hydrogen gas to be stored in the hydrogen storage part.

11. The fuel-cell-system according to claim 9, further comprising a water electrolysis part that electrolytically generates a hydrogen gas and an oxygen gas, wherein the hydrogen storage part stores the hydrogen gas that is generated by the water electrolysis part and dehumidified by the dehumidifying part.

12. The fuel-cell-system according to claim 11, further comprising a photoelectric conversion part that is configured to output a photovoltaic power to the water electrolysis part.

13. The fuel-cell-system according to claim 12, wherein the photoelectric conversion part has a light acceptance surface and a back surface, and the water electrolysis part is provided on the back surface of the photoelectric conversion part, wherein the photoelectric conversion part and the water electrolysis part compose a hydrogen production device.

14. The fuel-cell-system according to claim 13, wherein the hydrogen production device comprises a first electrolysis electrode and a second electrolysis electrode, which are respectively formed on the back surface of the photoelectric conversion part, wherein, when the light acceptance surface of the photoelectric conversion part is irradiated with light, and the first and second electrolysis electrodes are brought into contact with an electrolytic solution, the first and second electrolysis electrodes can electrolyze the electrolytic solution to generate a first gas and a second gas by utilizing the electromotive force generated by the photoelectric conversion part receiving light, one of the first and second gases being a hydrogen gas, and the other being an oxygen gas.

15. The fuel-cell-system according to claim 14, wherein the photoelectric conversion part is configured to generate an electromotive force between the light acceptance surface and the back surface when being irradiated with light, the first electrolysis electrode is configured to be capable of being electrically connected to the back surface of the photoelectric conversion part, and the second electrolysis electrode is configured to be capable of being electrically connected to the light acceptance surface of the photoelectric conversion part.

16. The fuel-cell-system according to claim 15, wherein the hydrogen production device further comprises an insulation part provided between the second electrolysis electrode and the back surface of the photoelectric conversion part.

17. The fuel-cell-system according to claim 16, wherein the hydrogen production device further comprises a first electrode that is in contact with the light acceptance surface of the photoelectric conversion part.

18. The fuel-cell-system according to claim 17, wherein the hydrogen production device further comprises a first conductive part that electrically connects the first electrode and the second electrolysis electrode.

19. The fuel-cell-system according to claim 18, wherein the first conductive part is formed in a contact hole penetrating the photoelectric conversion part.

20. The fuel-cell-system according to claim 18, wherein the insulation part is provided to cover the side face of the photoelectric conversion part, and the first conductive part is provided on a portion that is a part of the insulation part and that covers the side face of the photoelectric conversion part.

21. The fuel-cell-system according to claim 17, wherein the insulation part is provided to cover the side face of the photoelectric conversion part, and the second electrolysis electrode is provided on a portion that is a part of the insulation part and that covers the side face of the photoelectric conversion part, and is brought into contact with the first electrode.

22. The fuel-cell-system according to claim 15, wherein the photoelectric conversion part has a photoelectric conversion layer formed of a p-type semiconductor layer, an i-type semiconductor layer, and an n-type semiconductor layer.

23. The fuel-cell-system according to claim 14, wherein the photoelectric conversion part generates a potential difference between first and second regions on the back surface of the photoelectric conversion part when being irradiated with light, wherein the first region is formed to be electrically connected to the first electrolysis electrode, while the second region is formed to be electrically connected to the second electrolysis electrode.

24. The fuel-cell-system according to claim 23, wherein the hydrogen production device further has an insulation part that is formed between the first and second electrolysis electrodes and the back surface of the photoelectric conversion part, and that has an opening on the first region and the second region.

25. The fuel-cell-system according to claim 23, wherein the photoelectric conversion part is formed of at least one semiconductor material having an n-type semiconductor part and a p-type semiconductor part, wherein one of the first and second regions is a part of the n-type semiconductor part, while the other is a part of the p-type semiconductor part.

26. The fuel-cell-system according to claim 14, wherein the hydrogen production device further has a translucent substrate, wherein the photoelectric conversion part is provided on the translucent substrate.

27. The fuel-cell-system according to claim 14, wherein the photoelectric conversion part comprises plural photoelectric conversion layers that are connected in series, wherein the plural photoelectric conversion layers supply the electromotive force generated by the light incidence into the photoelectric conversion part to the first electrolysis electrode and the second electrolysis electrode.

28. The fuel-cell-system according to claim 14, wherein one of the first electrolysis electrode and the second electrolysis electrode is a hydrogen generation part generating H₂ from the electrolytic solution, while the other is an oxygen generation part generating O₂ from the electrolytic solution, wherein the hydrogen generation part contains a hydrogen generation catalyst that is a catalyst for a reaction to generate H₂ from the electrolytic solution, and the oxygen generation part contains an oxygen generation catalyst that is a catalyst for a reaction to generate O₂ from the electrolytic solution.

29. The fuel-cell-system according to claim 28, wherein at least one of the hydrogen generation part and the oxygen generation part has a catalytic surface area larger than an area of the light acceptance surface.

30. The fuel-cell-system according to claim 28, wherein at least one of the hydrogen generation part and the oxygen generation part is formed of a catalyst-supporting porous conductor.

31. The fuel-cell-system according to claim 28, wherein the hydrogen generation part contains at least one of Pt, Ir, Ru, Pd, Rh, Au, Fe, Ni, and Se.

32. The fuel-cell-system according to claim 28, wherein the oxygen generation part contains at least one of Mn, Ca, Zn, Co, and Ir.

33. The fuel-cell-system according to claim 14, wherein the hydrogen production device comprises a translucent substrate, an electrolytic solution chamber, and a back substrate provided on the first electrolysis electrode and the second electrolysis electrode, wherein the photoelectric conversion part is provided on the translucent substrate, and the electrolytic solution chamber is provided between the first and second electrolysis electrodes and the back substrate.

34. The fuel-cell-system according to claim 33, wherein the hydrogen production device further comprises a partition wall to separate the electrolytic solution chamber between the first electrolysis electrode and the back substrate, and the electrolytic solution chamber between the second electrolysis electrode and the back substrate.

35. The fuel-cell-system according to claim 34, wherein the partition wall includes an ion exchanger.
